(19) United States
(12) Patent Application Publication
(10) Pub. No.: US 2025/0214315 A1
(43) Pub. Date: Jul. 3, 2025

(54) VEHICLE INTERIOR MATERIAL

(71) Applicant: TS TECH CO., LTD., Asaka-shi, Saitama (JP)

(72) Inventors: Hiroshi YOSHIDA, Tochigi (JP); Tatsuya MIYAMOTO, Tochigi (JP); Takahiro SHIMIZU, Tochigi (JP); Ryoichiro TAKEZAWA, Tochigi (JP); Kengo KONO, Tochigi (JP)

(21) Appl. No.: 18/848,441

(22) PCT Filed: Apr. 14, 2023
(86) PCT No.: PCT/JP2023/015182

§ 371 Date: Sep. 18, 2024

Related U.S. Application Data
(60) Provisional application No. 63/364,350, filed on May 9, 2022.
(60) Provisional application No. 63/395,960, filed on Aug. 8, 2022.

(30) Foreign Application Priority Data
Apr. 15, 2022 (JP) 2022-067465
Feb. 28, 2023 (JP) 2023-029231
Mar. 30, 2023 (JP) 2023-055099

(51) Int. Cl. B32B 3/30; B32B 3/26; B32B 5/18; B60N 2/75; B60R 13/02

(52) U.S. Cl. CPC B32B 3/30; B32B 3/266; B32B 5/18; B60R 13/0243; B32B 2250/04; B32B 2307/102; B32B 2307/72; B32B 2605/003; B60N 2/78

(57) ABSTRACT

A vehicle interior material includes a base material, and a skin material joined to the base material. The skin material includes a skin layer, a foaming layer provided on a surface of the skin layer on a side of the base material, and a solid layer provided on a surface of the foaming layer on the side of the base material, having a higher density than the foaming layer, and having breathability. The skin material has a plurality of first recesses recessed from the solid layer toward the foaming layer.

### TECHNICAL FIELD

The present invention relates to a vehicle interior material.

### BACKGROUND ART

Patent Document 1 and Patent Document 2 disclose a layered body (vehicle interior material) including a base material, and a skin material joined to the base material. The skin material is formed by joining together a skin sheet that forms the exterior and a foam sheet. The vehicle interior material is formed by joining together the skin material on a side of the foam sheet and the base material.

Publicly known methods for joining the base material and the skin material together include pressure joining by an adhesive (Patent Document 2) and pressure joining by melting a hot melt sheet arranged between the base material and the skin material (Patent Document 3).

### PRIOR ART DOCUMENT(S)

### Patent Document(s)

Patent Document 1: JP1997-52246A
Patent Document 2: JP2021-109321A
Patent Document 3: JP2009-83411A

### SUMMARY OF THE INVENTION

### Task to be Accomplished by the Invention

During the joining process of the base material and the skin material, an air pool may occur between the base material and the skin material. The air pool may cause the separation or lifting of the foam sheet and the base material.

In view of the above background, an object of the present invention is to suppress the formation of an air pool between a skin material and a base material in a vehicle interior material.

### Means to Accomplish the Task

To achieve such an object, one aspect of the present invention provides a vehicle interior material (1) comprising: a base material (6); and a skin material (7) joined to the base material, wherein the skin material includes: a skin layer (8); a foaming layer (9) provided on a surface of the skin layer on a side of the base material; and a solid layer (10) provided on a surface of the foaming layer on the side of the base material and having a higher density than the foaming layer, and the skin material has a plurality of first recesses (12) recessed from the solid layer toward the foaming layer.

According to this aspect, the air between the skin material and the base material is pushed out toward an outside of the vehicle interior material along each first recess. Accordingly, the formation of an air pool between the skin material and the base material is suppressed.

In the above aspect, preferably, each of a bottom of the plurality of first recesses reaches the foaming layer.

According to this aspect, since the plurality of first recesses is formed larger, the air between the skin material and the base material is more effectively pushed out toward the outside of the vehicle interior material. Accordingly, the formation of the air pool between the skin material and the base material is more effectively suppressed.

In the above aspect, preferably, a surface of the base material joined to the solid layer has a plurality of second recesses (14) recessed toward an inside of the base material.

According to this aspect, more air passages toward the outside of the vehicle interior material are formed by the second recesses in addition to the first recesses. Accordingly, the air between the skin material and the base material can be more effectively pushed out toward the outside of the vehicle interior material. Accordingly, the formation of the air pool between the skin material and the base material is more effectively suppressed.

In the above aspect, preferably, when the base material and the skin material are joined together, a portion of the plurality of first recesses and a portion of the plurality of second recesses are arranged to face each other.

According to this aspect, larger air passages toward the outside of the vehicle interior material are formed by the second recesses in addition to the first recesses. Accordingly, the air between the skin material and the base material can be more effectively pushed out toward the outside of the vehicle interior material. Accordingly, the formation of the air pool between the skin material and the base material is more effectively suppressed.

In the above aspect, preferably, the foaming layer is breathable, and the skin layer has a plurality of through holes (16) penetrating from a top surface of the skin layer to a back surface of the skin layer.

According to this aspect, in addition to the air passages formed by the first recesses, the air passages passing through the foaming layer to reach the through holes are formed. Accordingly, the air between the skin material and the base material can be more effectively pushed out toward the outside of the vehicle interior material. Accordingly, the formation of the air pool between the skin material and the base material is suppressed. In the above aspect, preferably, each of the plurality of through holes is aligned with a portion of the plurality of first recesses in a side view.

According to this aspect, the air passages become the shortest at the through holes and the first recesses that are aligned. Accordingly, the air between the skin material and the base material can be more effectively pushed out toward the outside of the vehicle interior material. Accordingly, the formation of the air pool between the skin material and the base material is suppressed.

In the above aspect, preferably, when the skin material and the base material are joined together, each of the plurality of through holes is aligned with a portion of the plurality of second recesses in a side view.

According to this aspect, the air passages become the shortest at the through holes and the second recesses that are aligned. Accordingly, the air between the skin material and the base material can be more effectively pushed out toward the outside of the vehicle interior material. Accordingly, the formation of the air pool between the skin material and the base material is suppressed.

In the above aspect, preferably, the base material has a plurality of second through holes (31) penetrating from a top surface of the base material to a back surface of the base material.

According to this aspect, the air between the skin material and the base material flows through the second through holes toward the outside of the vehicle interior material. Accordingly, the formation of the air pool between the skin material and the base material is more effectively suppressed.

In the above aspect, preferably, when the skin material and the base material are joined together, each of the plurality of second through holes is aligned with a portion of the plurality of first recesses in a side view.

According to this aspect, the first recesses communicate with the outside via the second through holes. That is, the air between the skin material and the base material flows toward the outside of the vehicle interior material not only along the first recesses but also through the second through holes. Accordingly, the formation of an air pool between the skin material and the base material is more effectively suppressed.

In the above aspect, preferably, the skin layer has a plurality of first through holes (16) penetrating from a top surface of the skin layer to a back surface of the skin layer, and when the skin material and the base material are joined together, each of the plurality of second through holes is aligned with a portion of the plurality of first through holes in a side view.

According to this aspect, the air between the skin material and the base material flows toward the outside of the vehicle interior material from the side of the base material and the side of the skin material. At this time, the air passages become the shortest. Accordingly, the formation of the air pool between the skin material and the base material is more effectively suppressed.

Patent Document 4 (JP2018-69651A) discloses a vehicle interior material including a base material and a skin material joined to the base material. The skin material described in Patent Document 4 is provided with an ornamental stitch to improve design properties.

The ornamental stitch described in Patent Document 4 is arranged on the skin material in a state of protruding outward from a top surface of the skin material. Accordingly, there is room for improvement in terms of design properties. Further, the ornamental stitch may be caught by an occupant and the like, which may damage the ornamental stitch.

An object of another aspect is to provide a vehicle interior material with improved design properties and durability in a manufacturing device of the vehicle interior material and a manufacturing method of the vehicle interior material.

To achieve such an object, a vehicle interior material (101) according to the present invention includes: a base material (112); and a skin material (107) joined to the base material and including a stitch (106), wherein a top surface of the base material to which the skin material is joined is provided with a groove (114) that receives a portion of the skin material provided with the stitch.

According to this aspect, the stitch is arranged in a portion recessed inside the skin material from a surface of the skin material. Accordingly, the vehicle interior material is provided with a plurality of bumps, so that a three-dimensional pattern is formed. That is, design properties are improved. The stitch is arranged in the portion recessed inside the skin material, which prevents the stitch from being caught by an occupant and the like. Accordingly, the damage to the stitch is suppressed. That is, the durability is improved.

In the above aspect, preferably, a depth of the groove is greater than a thickness of the stitch.

According to this aspect, the stitch is arranged in a state of being recessed from a top surface to a back surface of the skin material.

In the above aspect, preferably, a plurality of through holes (118) penetrating from the top surface of the base material to a back surface of the base material is formed in the base material.

According to this aspect, when the portion of the skin material provided with the stitch is pressed to the groove of the base material, the air contained in the groove is pushed out toward an outside of the vehicle interior material through the through holes. Accordingly, the formation of an air pool between the skin material and the base material is suppressed.

In the above aspect, preferably, the through holes are formed so as to penetrate from the top surface of the base material provided with the groove to the back surface of the base material.

According to this aspect, when the portion of the skin material provided with the stitch is pressed to the groove of the base material, the air contained in the groove is pushed out toward the outside of the vehicle interior material through the through holes. Accordingly, the formation of the air pool between the portion of the skin material provided with the stitch and the groove is suppressed.

In the above aspect, preferably, an edge of the groove is provided with a chamfer (116) that slopes from the top surface of the base material toward a bottom of the groove.

According to this aspect, when the skin material and the base material are joined together, the edge of the groove is prevented from damaging the skin material.

In the above aspect, preferably, a portion of the stitch is aligned with a component of the chamfer in a depth direction of the groove.

According to this aspect, the stitch is arranged in a state of being recessed from the top surface to the back surface of the skin material.

In the above aspect, preferably, the portion of the skin material provided with the stitch is provided with a tape material (117).

According to this aspect, positioning for arranging the stitch on the groove is facilitated.

Another aspect is a manufacturing method of a vehicle interior material (101) for forming the vehicle interior material by joining together a skin material (107) including a stitch (106) and a base material (112) provided with a groove (114) that receives a portion of the skin material provided with the stitch, wherein a manufacturing device (120) for joining the skin material and the base material together includes a first die (121) and a second die (122) that are movable relative to each other in a pressing direction to press the skin material and the base material, and one of the first die and the second die is provided with a protrusion (123) protruding toward the other thereof, the manufacturing method comprising: an arranging step ((A) of FIG. 13) arranging the base material and the skin material between the first die and the second die such that the stitch, the groove, and the protrusion are aligned; and a pressing step ((B) of FIG. 13) moving the first die and the second die close to each other and pressing the skin material and the base material.

According to this aspect, the portion of the skin material provided with the stitch is pressed to the groove of the base material by the protrusion. Accordingly, the vehicle interior material is provided with a plurality of bumps, so that a three-dimensional pattern is formed. That is, it is possible to provide a vehicle interior material with improved design properties.

In the above aspect, preferably, the protrusion is configured to be movable in the pressing direction, and the pressing step includes: a first pressing step ((B) of FIG. 14) for pressing a portion other than the portion of the skin material provided with the stitch against the base material; and a second pressing step ((C) of FIG. 14), after the first pressing step, moving the protrusion and pressing the portion of the skin material provided with the stitch against the groove.

According to this aspect, the pressing step pressing the skin material and the base material is performed stepwise in the first pressing step and the second pressing step. Accordingly, the formation of the air pool between the skin material and the base material is suppressed.

In the above aspect, preferably, the portion of the skin material provided with the stitch is provided with a tape material, and the arranging step aligning the tape material with the groove.

According to this aspect, positioning for arranging the stitch on the groove is facilitated.

Another aspect is a manufacturing device (120) of a vehicle interior material (101) for joining together a skin material (107) provided with a stitch (106) and a base material (112), the manufacturing device comprising a first die (121) and a second die (122) that are movable relative to each other in a pressing direction to press the skin material and the base material, wherein one of the first die and the second die is provided with a protrusion (123) protruding toward the other thereof.

According to this aspect, the portion of the skin material provided with the stitch is pressed to the groove of the base material by the protrusion. Accordingly, the vehicle interior material is provided with a plurality of bumps, so that a three-dimensional pattern is formed. That is, it is possible to provide a vehicle interior material with improved design properties.

In the above aspect, preferably, the protrusion is configured to be movable in the pressing direction.

According to this aspect, the portion of the skin material provided with the stitch and the remaining portion thereof can be pressed to the base material stepwise. Accordingly, the formation of the air pool between the skin material and the base material is suppressed.

In Patent Document 5 (JP2005-53435A), a vehicle interior material that attaches a skin material for decoration to a base material so as to decorate the interior of a vehicle cabin is publicly known. In this vehicle interior material, the skin material is attached to the base material by pushing an engagement member to which the skin material is joined into a groove provided in the base material.

In the interior material of Patent Document 5, the engagement member pressed into the groove protrudes from a top surface of the base material. Accordingly, a thick cushion pad is provided between the skin material and the base material to make a top surface of the skin material flat. However, in a case where the thickness is not required between the skin material and the base material, the protruding portion of the engagement member becomes obstructive, which results in an undesirable appearance.

A second object of another aspect is to facilitate the attachment of a skin material to a base material and to attach an engagement member flat to the base material in a vehicle interior material.

Another aspect provides a vehicle interior material (210), comprising: a base material (211) provided on an inboard side of a panel of a vehicle body; a skin material (212) that covers the base material from the inboard side; and an engagement member (240) for attaching the skin material to the base material, wherein a first groove (220) and a second groove (218) that is formed around the first groove and shallower than the first groove are formed in an inboard side portion (214) of the base material, the engagement member includes: a plate (242) joined to an outboard side portion of the skin material and received by the second groove; and a locked portion (243) protruding from the plate, inserted into the first groove, and locked by the first groove, and an inboard side surface of the plate is flush with an inboard side portion of the base material.

According to this aspect, it is possible to attach the skin material to the base material by pressing the engagement member. Accordingly, the attachment of the skin material to the base material can be facilitated. Further, since the inboard side surface of the plate is flush with the inboard side portion of the base material, it is possible to attach the engagement member flat to the base material.

In the above aspect, preferably, the skin material includes: a first skin portion (251); and a second skin portion (252) overlapping with the first skin portion and thereby forming an overlapping portion (253), and the first skin portion and the second skin portion are sewn to the plate at the overlapping portion.

According to this aspect, it is possible to attach the two skin portions to the locking member by sewing.

In the above aspect, preferably, the second skin portion is arranged closer to the inboard side than the first skin portion and folded back to an outboard side at the overlapping portion.

According to this aspect, the tips of the first skin portion and the second skin portion are not visible from the inboard side. Accordingly, the appearance inside a vehicle cabin can be improved.

In the above aspect, preferably, the locked portion is offset toward the first skin portion relative to the plate.

According to this aspect, since an area of the plate on a side of the second skin portion becomes large, it is possible to easily sew the skin material to the plate. Further, since the locked portion is offset relative to the plate, the attachment direction of the engagement member can be easily determined.

In the above aspect, preferably, the first groove includes a retaining portion for locking the locked portion.

According to this aspect, the engagement member can be securely locked to the base material. Accordingly, the skin material can be securely attached to the base material.

In the above aspect, preferably, the first groove includes a receiving portion (227 and 228) protruding from the base material toward the outboard side and covering the locked portion, the first groove includes: an opening area (226) that is provided with a first hole (230) facing the receiving portion and the locked portion; and a closed area (225) that does not include the first hole, and a thickness of the receiving portion in the closed area is thinner than a thickness of the locked portion.

According to this aspect, the thickness of the receiving portion is made thinner. Accordingly, when the locked portion is inserted into the first groove, the receiving portion is likely to bend. Accordingly, the engagement member can be easily attached to the base material.

In the above aspect, preferably, the retaining portion is provided at a position corresponding to the opening area.

According to this aspect, the attachment of the engagement member is facilitated as compared with a case where the retaining portion is provided over the entire base material. Accordingly, the workability is improved.

In the above aspect, preferably, the base material includes a plate-like curved plate portion (215) having a bulging surface bulging toward the inboard side, the curved plate portion has an arc-like edge (255) defining an outer edge of the bulging surface and having an arc-like shape in a side view, the skin material is arranged to cover the bulging surface from the inboard side, a resilient wire (256) extending along the arc-like edge is provided at an outboard side surface of the curved plate portion at a position of the skin material corresponding to the arc-like edge, and the resilient wire resiliently abuts against the outboard side surface of the curved plate portion so as to lock the skin material on the arc-like edge.

According to this aspect, an outer edge of the skin material can be easily attached to the base material.

In the above aspect, preferably, the interior material constitutes an armrest (205) of a vehicle door (201), and a plurality of engagement members is arranged along a longitudinal direction of the armrest.

According to this aspect, it is possible to provide an armrest including an interior material that facilitates the attachment of the skin material to the base material and enables the engagement member to be attached flat to the base material. Further, since the plurality of engagement members is provided, the skin material can be securely attached even when the base material is large.

### Effect of the Invention

To achieve such an object, one aspect of the present invention provides a vehicle interior material (1) comprising: a base material (6); and a skin material (7) joined to the base material, wherein the skin material includes: a skin layer (8); a foaming layer (9) provided on a surface of the skin layer on a side of the base material; and a solid layer (10) provided on a surface of the foaming layer on the side of the base material and having a higher density than the foaming layer, and the skin material has a plurality of first recesses (12) recessed from the solid layer toward the foaming layer.

According to this aspect, the air between the skin material and the base material is pushed out toward an outside of the vehicle interior material along each first recess. Accordingly, the formation of an air pool between the skin material and the base material is suppressed.

In the above aspect, preferably, each of a bottom of the plurality of first recesses reaches the foaming layer.

According to this aspect, since the plurality of first recesses is formed larger, the air between the skin material and the base material is more effectively pushed out toward the outside of the vehicle interior material. Accordingly, the formation of the air pool between the skin material and the base material is more effectively suppressed.

In the above aspect, preferably, a surface of the base material joined to the solid layer has a plurality of second recesses (14) recessed toward an inside of the base material.

According to this aspect, more air passages toward the outside of the vehicle interior material are formed by the second recesses in addition to the first recesses. Accordingly, the air between the skin material and the base material can be more effectively pushed out toward the outside of the vehicle interior material. Accordingly, the formation of the air pool between the skin material and the base material is more effectively suppressed.

In the above aspect, preferably, when the base material and the skin material are joined together, a portion of the plurality of first recesses and a portion of the plurality of second recesses are arranged to face each other.

According to this aspect, larger air passages toward the outside of the vehicle interior material are formed by the second recesses in addition to the first recesses. Accordingly, the air between the skin material and the base material can be more effectively pushed out toward the outside of the vehicle interior material. Accordingly, the formation of the air pool between the skin material and the base material is more effectively suppressed.

In the above aspect, preferably, the foaming layer is breathable, and the skin layer has a plurality of through holes (16) penetrating from a top surface of the skin layer to a back surface of the skin layer.

According to this aspect, in addition to the air passages formed by the first recesses, the air passages passing through the foaming layer to reach the through holes are formed. Accordingly, the air between the skin material and the base material can be more effectively pushed out toward the outside of the vehicle interior material. Accordingly, the formation of the air pool between the skin material and the base material is suppressed.

In the above aspect, preferably, each of the plurality of through holes is aligned with a portion of the plurality of first recesses in a side view.

According to this aspect, the air passages become the shortest at the through holes and the first recesses that are aligned. Accordingly, the air between the skin material and the base material can be more effectively pushed out toward the outside of the vehicle interior material. Accordingly, the formation of the air pool between the skin material and the base material is suppressed.

In the above aspect, preferably, when the skin material and the base material are joined together, each of the plurality of through holes is aligned with a portion of the plurality of second recesses in a side view.

According to this aspect, the air passages become the shortest at the through holes and the second recesses that are aligned. Accordingly, the air between the skin material and the base material can be more effectively pushed out toward the outside of the vehicle interior material. Accordingly, the formation of the air pool between the skin material and the base material is suppressed.

In the above aspect, preferably, the base material has a plurality of second through holes (31) penetrating from a top surface of the base material to a back surface of the base material.

According to this aspect, the air between the skin material and the base material flows through the second through holes toward the outside of the vehicle interior material. Accordingly, the formation of the air pool between the skin material and the base material is more effectively suppressed.

In the above aspect, preferably, when the skin material and the base material are joined together, each of the plurality of second through holes is aligned with a portion of the plurality of first recesses in a side view.

According to this aspect, the first recesses communicate with the outside via the second through holes. That is, the air between the skin material and the base material flows toward the outside of the vehicle interior material not only along the first recesses but also through the second through holes. Accordingly, the formation of an air pool between the skin material and the base material is more effectively suppressed.

In the above aspect, preferably, the skin layer has a plurality of first through holes (16) penetrating from a top surface of the skin layer to a back surface of the skin layer, and when the skin material and the base material are joined together, each of the plurality of second through holes is aligned with a portion of the plurality of first through holes in a side view.

According to this aspect, the air between the skin material and the base material flows toward the outside of the vehicle interior material from the side of the base material and the side of the skin material. At this time, the air passages become the shortest. Accordingly, the formation of the air pool between the skin material and the base material is more effectively suppressed.

### BRIEF DESCRIPTION OF THE DRAWING(S)

FIG. 1 is a perspective view showing a door trim according to the present embodiment;

FIG. 2 is a cross-sectional view showing a main portion of the door trim according to the first embodiment;

FIG. 3 is an explanatory diagram illustrating a joint between a base material and a skin material;

FIG. 4 is a cross-sectional view showing a main portion of a door trim according to the second embodiment;

FIG. 5 is a cross-sectional view showing a main portion of a door trim according to the third embodiment;

FIG. 6 is a cross-sectional view showing a main portion of a door trim according to the fourth embodiment;

FIG. 7 is a cross-sectional view showing a main portion of a door trim according to the fifth embodiment;

FIG. 8 is a cross-sectional view showing a main portion of a door trim according to the sixth embodiment;

FIG. 9 is a cross-sectional view showing a main portion of a door trim according to the seventh embodiment;

FIG. 10 is a perspective view showing a door trim according to the eighth embodiment;

FIG. 11 is a diagram showing a stitch provided on the door trim according to the eighth embodiment;

FIG. 12 is a cross-sectional view showing the stitch provided on the door trim according to the eighth embodiment;

FIG. 13 is an explanatory diagram illustrating a joint between a base material and a skin material according to the eighth embodiment;

FIG. 14 is an explanatory diagram illustrating a joint between a base material and a skin material according to the ninth embodiment;

FIG. 15 is a front view of a vehicle door provided with an interior material according to the tenth embodiment;

FIG. 16 is a cross-sectional view of the interior material;

FIG. 17 is a schematic perspective view showing an outboard side surface of an outboard side portion;

FIG. 18 is a cross-sectional view along a line “XVIII-XVIII” in FIG. 17;

FIG. 19 is a cross-sectional view along a line “XIX-XIX” in FIG. 17; and

FIG. 20 is a diagram showing an attachment manner of a skin material in a rear portion of a base material.

### MODE(S) FOR CARRYING OUT THE INVENTION

### First Embodiment

In the following, a vehicle interior material of the present invention will be described with reference to the drawings. The vehicle interior material is an interior material provided on a portion of a vehicle body facing a vehicle cabin side. The vehicle interior material includes, for example, a door trim provided on an inner surface of a door, a glove compartment, an instrument panel, a center console, a roof lining, and the like. In the present embodiment, the vehicle interior material is applied to a door trim 1 on a driver's seat side.

In the following, the descriptions will be given such that the traveling direction of a vehicle in which the door trim 1 is installed is defined as “front-and-rear direction”, an inside in the vehicle width direction (lateral direction) is defined as “inboard side”, and an outside in the vehicle width direction (lateral direction) is defined as “outboard side”.

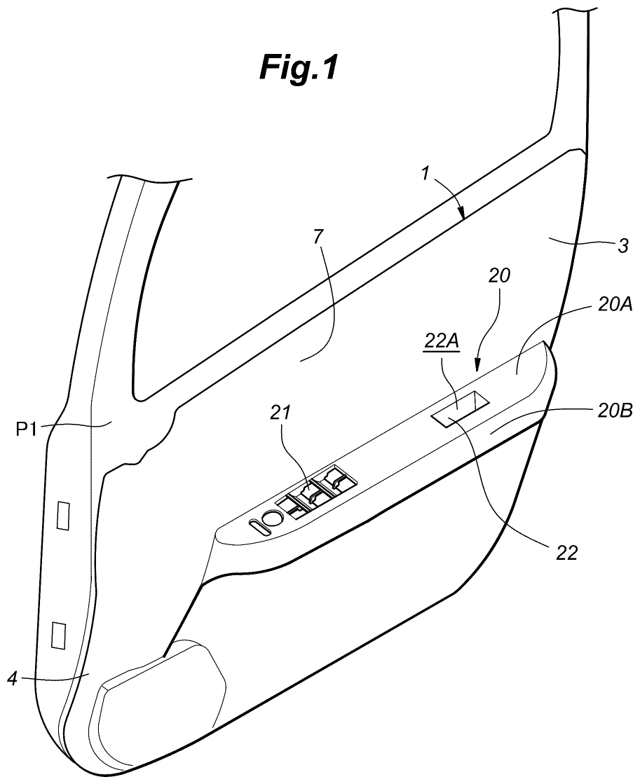

As shown in FIG. 1, the door trim 1 is provided on the inboard side of a metal (for example, iron) door panel P1. The door trim 1 has a main surface 3 facing the inboard side in the vehicle width direction, and an edge 4 corresponding to a circumferential edge of the main surface 3. The edge 4 extends from an end of the main surface 3 toward the outboard side. The edge 4 abuts against the door panel P1, and is attached to the door panel P1 via an unshown fastening member such as a clip, for example.

A central portion of the door trim 1 is provided with an armrest 20 that bulges toward the inboard side. The armrest 20 includes an upper wall 20A that protrudes toward the inboard side and having a main surface facing the up-and-down direction, and a sidewall 20B extending from an inboard side edge of the upper wall 20A toward the main surface 3 while sloping downward and toward the outboard side. The upper wall 20A extends horizontally from the main surface 3 toward the inboard side. The occupant can place his/her arm on a top surface of the upper wall 20A. Accordingly, the armrest 20 functions as an armrest.

A switch unit 21 for an occupant to perform an open/close operation of a window and the like is provided on a front portion of the upper wall 20A of the armrest 20. A pull pocket body 22 that defines a pull pocket space 22A recessed downward from the upper wall 20A of the armrest 20 is provided at a rear portion of the upper wall 20A of the armrest 20. The pull pocket body 22 functions as a gripping portion for the occupant to grip when opening and closing the door.

The main surface 3 is provided with a skin material 7. The skin material 7 is a layered body including a skin layer 8 and a foaming layer 9 described below, and has design properties, sound absorbing properties, and cushioning properties.

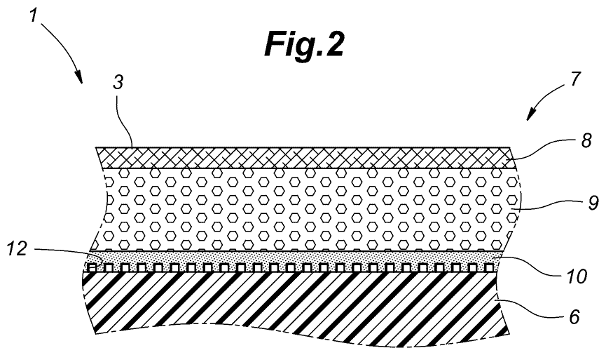

As shown in FIG. 2, the door trim 1 includes a base material 6 joined to the skin material 7. The base material 6 is made of hard resin having rigidity, and is provided to form a skeleton of the door trim 1. That is, the base material 6 forms a skeleton of the main surface 3, a skeleton of the armrest 20, and a skeleton of the pull pocket body 22. The skin material 7 is provided to cover the inboard side of the base material 6.

The skin material 7 includes the skin layer 8 and the foaming layer 9 provided on a surface of the skin layer 8 on a side of the base material 6. The skin layer 8 is provided on the most inboard side of the door trim 1, that is, provided at a position visible to the occupant. The skin layer 8 is formed into a sheet made of flexible resin, natural leather, synthetic leather, and the like to ensure design properties of the skin material 7.

The skin material 7 may be formed of thermoplastic elastomer (for example, olefin-based thermoplastic elastomer (TPO), polyvinyl chloride thermoplastic elastomer (TPVC), and the like) or polyvinyl chloride resin (PVC). The thermoplastic elastomer (TPO, TPVC, and the like) has rubber-like elasticity as compared with polyvinyl chloride resin (PVC). Accordingly, the sensation is improved when the occupant touches the skin material 7.

The foaming layer 9 is formed into a plate made by foaming synthetic resin using a known method, and is breathable and elastic. In other words, the foaming layer 9 has a porous structure. The synthetic resin may be, for example, polyurethane resin (PUR), polystyrene resin (PS), polyolefin resin (polyethylene resin, polypropylene resin) and the like. The foaming layer 9 provides the skin material 7 with sound absorbing properties, thereby preventing sound from inside a vehicle cabin from leaking out to the outside of the vehicle. Further, the foaming layer 9 provides the skin material 7 with cushioning properties, thereby also functioning to protect the occupant (to mitigate the shock) in the event of a collision.

In forming the door trim 1, first, the skin layer 8 and the foaming layer 9 are joined together to form the skin material 7. The skin layer 8 and the foaming layer 9 may be joined together by a known method such as heat fusion. For example, the skin layer 8 and the foaming layer 9 may be pressed and fused together using a first die device having a first upper die and a first lower die that are movable in the up-and-down direction and openable and closable relative to each other. The skin layer 8 and the foaming layer 9 are arranged between the first upper die and the first lower die in a laminated state. Thereafter, the first upper die and the first lower die are closed, thereby pressing the skin layer 8 and the foaming layer 9 together in the up-and-down direction. At this time, the skin layer 8 and the foaming layer 9 are heated. Accordingly, a surface of the foaming layer 9 that abuts against the skin layer 8 melts and then hardens, thereby fusing the skin layer 8 and the foaming layer 9 together.

A solid layer 10 having a higher density than the foaming layer 9 is formed on a surface of the foaming layer 9 on the side of the base material 6. That is, the solid layer 10 has a joint surface joined to the base material 6. The solid layer 10 may be formed during the process of forming the skin material 7, or may be appropriately formed after the skin material 7 is formed. The solid layer 10 is a layer formed by heating a surface of the foaming layer 9 on a side to be joined to the base material 6 and breaking air bubbles (gaps) present in the portion to cause the portion to have higher density than the foaming layer 9. Accordingly, the solid layer 10 is not breathable. A surface of the solid layer 10 is not smooth, but has bumps according to the shape of the broken air bubbles. The solid layer 10 has higher density than the foaming layer 9, so that an area of the solid layer 10 to abut against the base material 6 is enlarged. Accordingly, the joint strength of the solid layer 10 and the base material 6 is ensured. In FIG. 2 and subsequent figures, to make the descriptions understandable, the foaming layer 9 and the solid layer 10 are shown with different hatching.

In another embodiment, an adhesive film instead of the solid layer 10 may be provided by lamination processing on the surface of the foaming layer 9 on the side of the base material 6. The adhesive film is made of resin such as polyolefin resin or ethylene vinyl acetate resin, and is the so-called hot melt adhesive that melts when heated. The thickness and basis weight of the adhesive film may be appropriately selected so as to ensure the joint strength of the foaming layer 9 and the base material 6.

A plurality of first recesses 12 recessed from the solid layer 10 toward the foaming layer 9 is formed in the skin material 7. Each of the plurality of first recesses 12 is formed by a tool such as sandpaper, and extends irregularly along the surface direction of the solid layer 10 while intersecting with each other. The ends of some of the plurality of first recesses 12 are formed to reach the corresponding side edges of the solid layer 10. Accordingly, the plurality of first recesses 12 is formed from an inside of the solid layer 10 in the surface direction to an outside (in the front-and-rear direction on the paper surface) of the solid layer 10 in the surface direction. In the present embodiment, to simplify the drawing, the first recesses 12 are arranged at equal intervals.

The plurality of first recesses 12 may form a lattice-like shape arranged in a prescribed pattern. Any pattern such as a pattern in longitudinal and width directions, a pattern in diagonal directions, and a combination thereof may be selected as the prescribed pattern so long as the pattern has a cross-like shape. In this case, the plurality of first recesses 12 may be formed by providing lattice-like protrusions on the first upper die or the first lower die that abuts against the foaming layer 9 at the formation of the skin material 7 and pressing the skin layer 8 and the foaming layer 9 together. Alternatively, the plurality of first recesses 12 may be formed using a prescribed tool after the formation of the skin material 7.

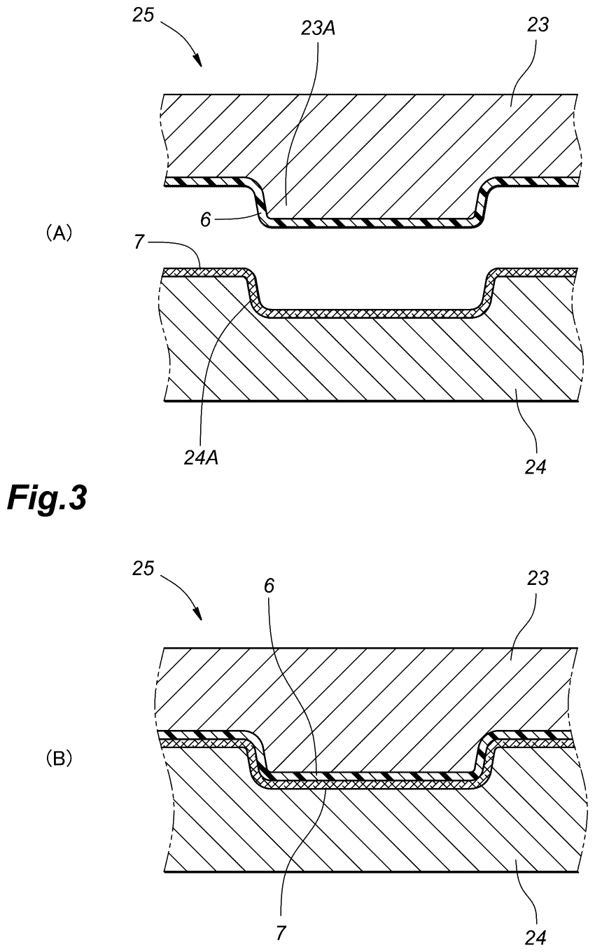

After the skin layer 8 and the foaming layer 9 are joined together to form the skin material 7, the skin material 7 and the base material 6 are joined together. The skin material 7 and the base material 6 may be joined together by a known method such as pressure joining. As shown in FIG. 3, a second die device 25 having a second upper die 23 and a second lower die 24 may be used to join the skin material 7 and the base material 6 together. The second upper die 23 and the second lower die 24 are movable in the up-and-down direction on the paper surface and can be opened and closed relative to each other. The second upper die 23 is provided with a protrusion 23A protruding toward the second lower die 24 and forms a product shape of the door trim 1. The second lower die 24 is provided with a recess 24A that forms the product shape of the door trim 1 and receives the protrusion 23A of the second upper die 23. The second upper die 23 is moved by an unshown cylinder relative to the second lower die 24 in the opening and closing direction.

As shown in (A) of FIG. 3, with the second upper die 23 and the second lower die 24 open to each other, the base material 6 is arranged on the protrusion 23A of the second upper die 23. At this time, an adhesive is applied in advance to a surface of the base material 6 to be joined to the skin material 7, that is, a surface facing the second lower die 24. The skin material 7 is provided in the recess 24A of the second lower die 24 such that the solid layer 10 faces the second upper die 23. At this time, the skin material 7 is preferably heated and softened. As shown in (B) of FIG. 3, after the base material 6 and the skin material 7 are arranged, the second upper die 23 is moved in a direction approaching the second lower die 24, that is, a lower side on the paper surface. Accordingly, the skin material 7 and the base material 6 are pressed together in the up-and-down direction on the paper surface and thereby joined together. Accordingly, the door trim 1 is formed.

When the skin material 7 and the base material 6 are pressed together in the up-and-down direction on the paper surface, the air between the skin material 7 and the base material 6 flows along each first recess 12 of the solid layer 10 toward each side edge (in the front-and-rear direction on the paper surface). That is, the air between the skin material 7 and the base material 6 is pushed out toward an outside of the door trim 1. Accordingly, the formation of an air pool between the skin material 7 and the base material 6 is suppressed.

### Second Embodiment

The door trim 1 according to the second embodiment differs from the door trim 1 according to the first embodiment only in the configuration of each first recess 12, and is identical thereto in the other configurations. In the following descriptions, the same components as those of the door trim 1 according to the first embodiment are given the same reference numerals and the descriptions thereof will be omitted.

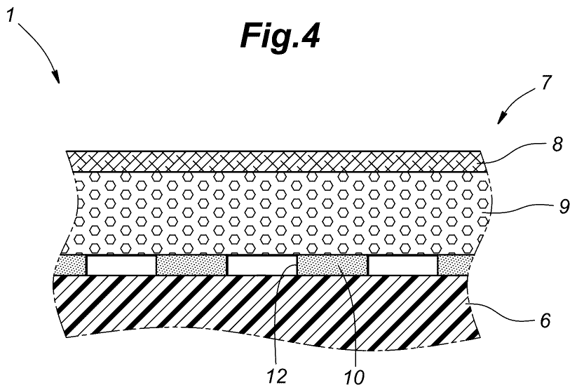

As shown in FIG. 4, each of the bottom of the plurality of first recesses 12 is formed to reach the foaming layer 9. That is, a portion of the foaming layer 9 is exposed to the outside. More specifically, each of the first recesses 12 is formed by cutting out a portion of the solid layer 10 with a tool and the like after forming the solid layer 10.

When a plurality of adhesive films is provided on the surface of the foaming layer 9 on the side of the base material 6, the plurality of adhesive films may be spaced away from each other. Accordingly, the foaming layer 9 is exposed to the outside via a portion corresponding to the space thereof.

The bottom of each of the plurality of first recesses 12 is formed to reach the foaming layer 9. Accordingly, when the skin material 7 and the base material 6 are pressed together in the up-and-down direction on the paper surface, the air between the base material 6 and the skin material 7 flows along the first recesses 12 toward each side edge of the solid layer 10 (in the front-and-rear direction on the paper surface) and toward the foaming layer 9 (upward on the paper surface). The air flowing toward the foaming layer 9 passes through each side edge of the foaming layer 9 along the gaps in the foaming layer 9 (in the front-and-rear direction on the paper surface and the lateral direction on the paper surface), and flows toward an outside of the foaming layer 9. That is, the air between the base material 6 and the skin material 7 is pushed out toward the outside of the door trim 1 by utilizing the breathability of the foaming layer 9. Accordingly, the formation of the air pool between the skin material 7 and the base material 6 is more effectively suppressed.

### Third Embodiment

The door trim 1 according to the third embodiment differs from the door trim 1 according to the first embodiment only in the configuration of the base material 6, and is identical thereto in the other configurations. In the following descriptions, the same components as those of the vehicle interior material according to the first embodiment are given the same reference numerals, and the descriptions thereof will be omitted.

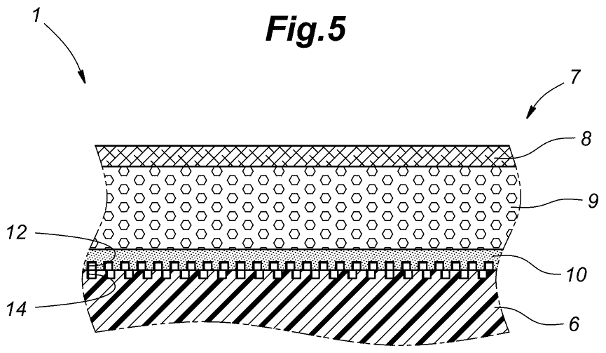

As shown in FIG. 5, a surface of the base material 6 joined to the foaming layer 9 has a plurality of second recesses 14 recessed toward an inside of the base material 6. The plurality of second recesses 14 may form a lattice-like shape arranged in a prescribed pattern. Any pattern such as a pattern in longitudinal and width directions, a pattern in diagonal directions, and a combination thereof may be selected as the prescribed pattern so long as the pattern has a cross-like shape. The plurality of second recesses 14 may be formed when the base material 6 is formed. Alternatively, the plurality of second recesses 14 may be formed using an appropriate tool so as to extend irregularly along the surface direction of the base material 6 while intersecting with each other. The ends of some of the plurality of second recesses 14 are formed so as to reach the corresponding side edge of the base material 6. Accordingly, the plurality of second recesses 14 is formed so as to reach an outside of the base material 6 in the surface direction from an inside of the base material 6 in the surface direction. In the present embodiment, to simplify the drawing, the second recesses 14 are arranged at equal intervals.

When the base material 6 and the skin material 7 are joined together, a portion of the plurality of second recesses 14 and a portion of the plurality of first recesses 12 are arranged to face each other. More specifically, when the base material 6 and the skin material 7 overlap with each other to be joined together, portions where a portion of the plurality of second recesses 14 and a portion of the plurality of first recesses 12 communicate with each other via respective openings thereof are provided between the base material 6 and the skin material 7. That is, the second recesses 14 and the first recesses 12 are integrated to form larger air passages.

Furthermore, when the base material 6 and the skin material 7 overlap with each other, portions where the plurality of first recesses 12 (second recesses 14) communicates with each other via a portion of the plurality of second recesses 14 (first recesses 12) are also provided between the base material 6 and the skin material 7. Accordingly, as compared with the first embodiment, more air passages are formed to reach the outside of the door trim 1, that is, each side edge of the solid layer 10 or each side edge of the base material 6.

When the skin material 7 and the base material 6 are pressed together in the up-and-down direction on the paper surface, the air between the skin material 7 and the base material 6 flows along the second recesses 14 in addition to the first recesses 12 toward each side edge of the solid layer 10 and the base material 6 (in the front-and-rear direction on the paper surface). Accordingly, the formation of the air pool between the skin material 7 and the base material 6 is more effectively suppressed.

### Fourth Embodiment

The door trim 1 according to the fourth embodiment is a combination of the door trim 1 according to the second embodiment and the door trim 1 according to the third embodiment. The door trim 1 according to the fourth embodiment differs from each embodiment only in the configuration of the skin layer 8, and is identical thereto in the other configurations. In the following descriptions, the same components as those of the door trim 1 in each embodiment are given the same reference numerals, and the descriptions thereof will be omitted.

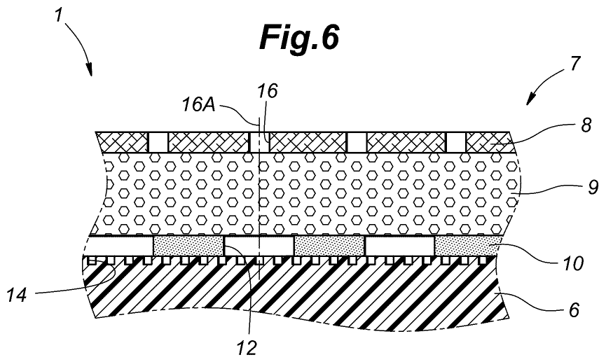

As shown in FIG. 6, a plurality of first through holes 16 penetrating from a top surface of the skin layer 8 to a back surface of the skin layer 8 is formed in the skin layer 8. The top surface of the skin layer 8 forms a surface visible to the occupant. The back surface of the skin layer 8 forms a joint surface joined to the foaming layer 9. The plurality of first through holes 16 may be formed to be spaced away from each other using needles and the like, for example. Alternatively, the plurality of first through holes 16 may be formed by providing a plurality of needles on the first upper die or the first lower die that abuts against the skin layer 8 at the formation of the skin material 7 and pressing the skin layer 8 and the foaming layer 9 together.

Each of the bottom of the plurality of first recesses 12 is formed to reach the foaming layer 9. That is, a portion of the foaming layer 9 is exposed to the outside. More specifically, each of the first recesses 12 is formed by cutting out a portion of the solid layer 10 with a tool and the like after forming the solid layer 10.

Each of the plurality of first through holes 16 is provided at a position that is aligned with a portion of the plurality of first recesses 12 and a portion of the plurality of second recesses 14 in a side view. More specifically, when the base material 6 and the skin material 7 overlap with each other to be joined together, a portion of a virtual line 16A formed by extending each of the plurality of first through holes 16 overlaps with a portion of the plurality of first recesses 12 and a portion of the plurality of second recesses 14 in a side view. The virtual line 16A is preferably formed so as to pass through a portion where the first recess 12 and the second recess 14 communicate with each other via respective openings thereof, but is not particularly limited thereto. For example, some of a plurality of virtual lines 16A may be formed so as to pass only through the corresponding first recess 12, or may be formed so as to pass only through the corresponding second recess 14.

When the skin material 7 and the base material 6 are pressed together in the up-and-down direction on the paper surface, the air between the skin material 7 and the base material 6 flows along the first recesses 12 and the second recesses 14 toward each side edge of the solid layer 10 and the base material 6 (in the front-and-rear direction on the paper surface), and flows toward the foaming layer 9 (upward on the paper surface). The air flowing toward the foaming layer 9 flows toward each side edge of the foaming layer 9 (in the front-and-rear direction on the paper surface and the lateral direction on the paper surface), and flows toward the skin layer 8 (upward on the paper surface). The air flowing toward the skin layer 8 passes through each first through hole 16, and flows toward the outside of the door trim 1 (upward on the paper surface).

A portion of the virtual line 16A formed by extending each of the plurality of first through holes 16 overlaps with a portion of the plurality of first recesses 12 and a portion of the plurality of second recesses 14 in a side view. In other words, each portion of the plurality of virtual lines 16A aligned with the foaming layer 9 and the solid layer 10 forms the shortest air passage from the corresponding first recess 12 to the corresponding first through hole 16 (in the up-and-down direction on the paper surface). Accordingly, the air flowing toward the foaming layer 9 can be more effectively pushed out toward an outside of the skin layer 8 after passing through the first through holes 16. Accordingly, the formation of the air pool between the skin material 7 and the base material 6 is more effectively suppressed.

Each of the plurality of first through holes 16 may be spaced away from each other and arranged in a prescribed direction, or may be arranged to form a single overall coherent shape or pattern. Accordingly, each of the plurality of first through holes 16 can ensure design properties of the door trim 1 while forming the shortest air passage.

In another embodiment, slits penetrating from the top surface of the skin layer 8 to the back surface of the skin layer 8 and extending in a prescribed direction included in the surface direction of the skin layer 8 may be formed in the skin layer 8. Accordingly, the air between the skin material 7 and the base material 6 passes through the slits and a cloth sheet, and is pushed out toward the outside of the door trim 1. The slits may be covered with, for example, the cloth sheet that is breathable. Accordingly, design properties of the door trim 1 are ensured.

### Fifth Embodiment

The door trim 1 according to the fifth embodiment differs from the door trim 1 according to the fourth embodiment only in the configuration of the base material 6, and is identical thereto in the other configurations. In the following descriptions, the same components as those of the door trim 1 according to the fourth embodiment are given the same reference numerals, and the descriptions thereof will be omitted.

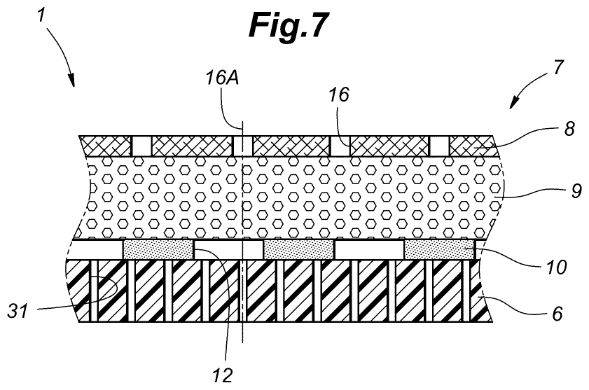

As shown in FIG. 7, the base material 6 has a plurality of second through holes 31 penetrating from a top surface of the base material 6 to a back surface of the base material 6. The top surface of the base material 6 forms a surface joined to the skin material 7. The back surface of the base material 6 forms a surface facing the outboard side when the door trim 1 is attached to the door panel P1. Each second through hole 31 may be provided when the base material 6 is formed, or may be provided by an appropriate tool after the base material 6 is formed.

Each of the plurality of second through holes 31 is provided at a position aligned with a portion of the plurality of first recesses 12 and a portion of the plurality of first through holes 16 in a side view. More specifically, when the base material 6 and the skin material 7 overlap with each other to be joined together, a portion of the plurality of second through holes 31 and the corresponding first recesses 12 communicate with each other via respective openings thereof. That is, the first recesses 12 communicate with the outside via the second through holes 31.

At this time, the first recess 12 corresponding to a portion of the plurality of second through holes 31 overlaps with a corresponding virtual line 16A formed by extending the first through hole 16. In other words, each portion of the plurality of virtual lines 16A aligned with the top surface of the skin layer 8 from the back surface of the base material 6 forms the shortest air passage in the up-and-down direction on the paper surface.

When the skin material 7 and the base material 6 are pressed together in the up-and-down direction on the paper surface, the air between the skin material 7 and the base material 6 flows along the first recesses 12 to each side edge of the solid layer 10 (in the front-and-rear direction on the paper surface). Further, the air between the skin material 7 and the base material 6 passes through the foaming layer 9 and flows toward each side edge of the foaming layer 9 (in the front-and-rear direction on the paper surface and the lateral direction on the paper surface), and passes through the plurality of first through holes 16 (upward on the paper surface) and flows toward the outside of the door trim 1. Further, the air between the skin material 7 and the base material 6 passes through the second through holes 31 (downward on the paper surface) and flows toward the outside of the door trim 1. Accordingly, the formation of the air pool between the skin material 7 and the base material 6 is more effectively suppressed.

In another embodiment, slits penetrating from the top surface of the base material 6 to the back surface of the base material 6 and extending in the surface direction of the base material 6 may be formed in the base material 6. Accordingly, the air between the skin material 7 and the base material 6 passes through the slits, and is pushed out toward the outside of the door trim 1.

### Sixth Embodiment

The door trim 1 according to the sixth embodiment differs from the door trim 1 according to the third embodiment only in the configurations of the foaming layer 9 and the solid layer 10, and is identical thereto in the other configurations. In the following descriptions, the same components as those of the door trim 1 according to the third embodiment are given the same reference numerals, and the descriptions thereof will be omitted.

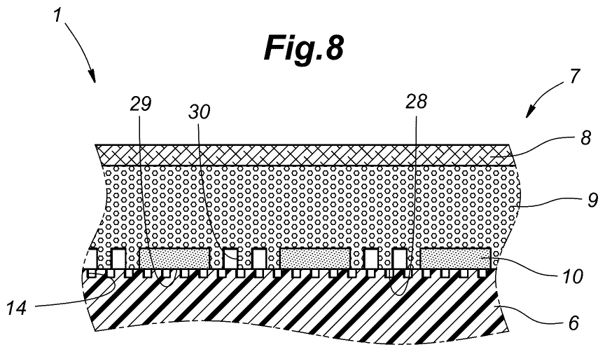

The foaming layer 9 is formed into a plate made by foaming synthetic resin using a known method, and is not breathable. The solid layer 10 is a layer formed by heating the surface of the foaming layer 9 on the side to be joined to the base material 6 and thereby deforming the foaming layer 9. As shown in FIG. 8, the foaming layer 9 joined to the base material 6 has a plurality of first surfaces 28 formed by the foaming layer 9, and a plurality of second surfaces 29 formed by the solid layer 10.

The first surfaces 28 formed by the foaming layer 9 are provided with a plurality of third recesses 30 recessed toward an inside of the foaming layer 9. Each of the plurality of third recesses 30 may be formed by a tool and the like, and may be formed to extend along the longitudinal direction of the corresponding first surface 28.

When the base material 6 and the skin material 7 overlap to be joined together, portions where a portion of the plurality of third recesses 30 and a portion of the plurality of second recesses 14 communicate with each other via respective openings thereof are provided between the base material 6 and the skin material 7. That is, the third recesses 30 and the second recesses 14 are integrated to form air passages.

When the skin material 7 and the base material 6 are pressed together in the up-and-down direction on the paper surface, the air between the skin material 7 and the base material 6 flows along the third recesses 30 and the second recesses 14 toward each side edge of the solid layer 10 and the base material 6 (in the front-and-rear direction on the paper surface). Since the air passages where the third recesses 30 and the second recesses 14 are integrated are provided, larger air passages are formed. Accordingly, the air between the skin material 7 and the base material 6 is pushed out toward the outside of the door trim 1 more effectively. Accordingly, when the base material 6 and the skin material 7 are joined together, the formation of the air pool between the skin material 7 and the base material 6 is suppressed even if the foaming layer 9 is made of a material that is not breathable.

### Seventh Embodiment

The door trim 1 according to the seventh embodiment is a combination of the door trim 1 according to the fifth embodiment and the door trim 1 according to the sixth embodiment. The door trim 1 according to the seventh embodiment is different from each embodiment only in the configuration of the foaming layer 9, and is identical thereto in the other configurations. In the following descriptions, the same components as those of the door trim 1 according to each embodiment are given the same reference numerals, and the descriptions thereof will be omitted.

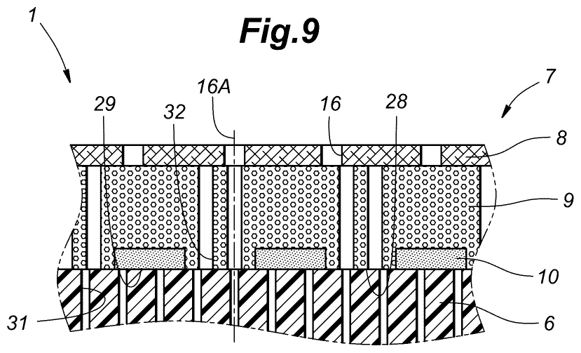

As shown in FIG. 9, the foaming layer 9 is provided with a plurality of third through holes 32 penetrating therethrough from a surface joined to the base material 6 to a surface joined to the skin layer 8. The third through holes 32 may be formed by an appropriate tool either before or after the foaming layer 9 is joined to the skin layer 8. Alternatively, the third through holes 32 may be provided when the foaming layer 9 is formed.

A portion of a virtual line 16A formed by extending each of the plurality of first through holes 16 overlaps with a portion of the plurality of third through holes 32 and a portion of the plurality of second through holes 31 in a side view. In other words, when the base material 6 and the skin material 7 overlap with each other to be joined together, the first through holes 16 and the second through holes 31 communicate with each other via the third through holes 32. That is, the door trim 1 includes portions penetrating therethrough from the inboard side to the outboard side.

When the base material 6 and the skin material 7 overlap with each other, the first through holes 16 and the second through holes 31 preferably communicate with each other via the third through holes 32, but are not particularly limited thereto. For example, some of the third through holes 32 may communicate with only some of the corresponding first through holes 16. Further, some of the third through holes 32 may communicate with only some of the corresponding second through holes 31. Further, when the first through holes 16, the second through holes 31, and the third through holes 32 communicate with each other, the axes thereof may be offset from each other.

When the base material 6 and the skin material 7 overlap with each other, the air between the skin material 7 and the base material 6 is pushed out toward the outside of the door trim 1 (in the up-and-down direction on the paper surface) via the first through holes 16, the second through holes 31, and the third through holes 32. Accordingly, even if the foaming layer 9 is made of a material that is not breathable, the formation of the air pool between the skin material 7 and the base material 6 is suppressed.

In another embodiment, the foaming layer 9 may be provided with slits penetrating therethrough from the surface joined to the base material 6 to the surface joined to the skin layer 8 and extending in the surface direction of the first surfaces 28.

This is the end of the descriptions of the specific embodiments, but the present invention can be widely modified without being limited to the above embodiments. For example, the skin layer 8, which is not breathable in the present embodiments, may be a breathable fabric sheet such as a nonwoven fabric. The configurations of each embodiment may be combined as appropriate.

### Eighth Embodiment

The vehicle interior material will be described below with reference to the drawings. The vehicle interior material is the interior material provided on the portion of the vehicle body facing the vehicle cabin side. The vehicle interior material includes, for example, the door trim provided on the inner surface of the door, the glove box, the instrument panel, the center console, the roof lining, and the like. In the present embodiment, the vehicle interior material is applied to the door trim 101 on the driver's seat side.

In the following explanation, the direction of travel of the vehicle in which the door trim 101 is provided is defined as the front-and-rear direction, the inside of the vehicle width direction (the lateral direction) is defined as the inboard side, and the outside of the vehicle width direction (the lateral direction) is defined as the outboard side.

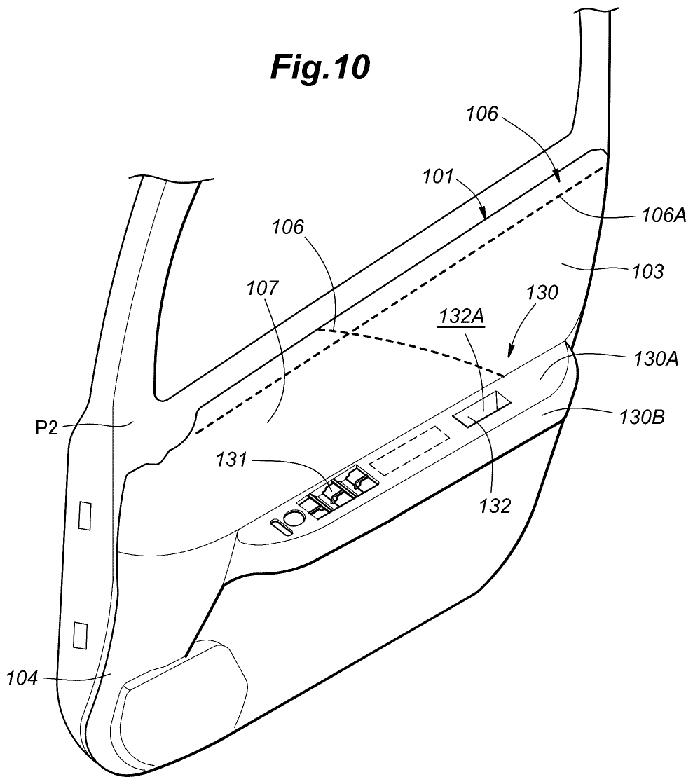

As shown in FIG. 10, the door trim 101 is provided on the inboard side of the door panel P2 which is made of metal (for example, iron). The door trim 101 has the main surface 103 which faces the inboard side in the vehicle width direction, and the edge 104 which corresponds to the circumferential edge of the main surface 103. The edge 104 extends from the end of the main surface 103 towards the outboard side. The edge 104 abuts against the door panel P2, and is attached to the door panel P2 via the fastening member, for example a clip (not shown).

The central portion of the door trim 101 is provided with the armrest 130 which bulges out towards the inboard side. The armrest 130 has an upper wall 130A which protrudes towards the inboard side and has its main surface facing up and down, and a sidewall 130B which extends from the inboard side edge of the upper wall 130A towards the main surface 103, sloping downward towards the outboard side. The upper wall 130A extends horizontally from the main surface 103 to the inboard side. The occupant can rest their arms on the top surface of the upper wall 130A. This allows the armrest 130 to function as an armrest.

The switch unit 131, which enables the occupant to open and close the window, is provided on the front portion of the upper wall 130A of the armrest 130. The pull pocket body 132, which defines the pull pocket space 132A recessed downward from the upper wall 130A of the armrest 130, is provided on the rear portion of the upper wall 130A of the armrest 130. The pull pocket body 132 functions as a gripping portion that the occupant grips when opening and closing the door.

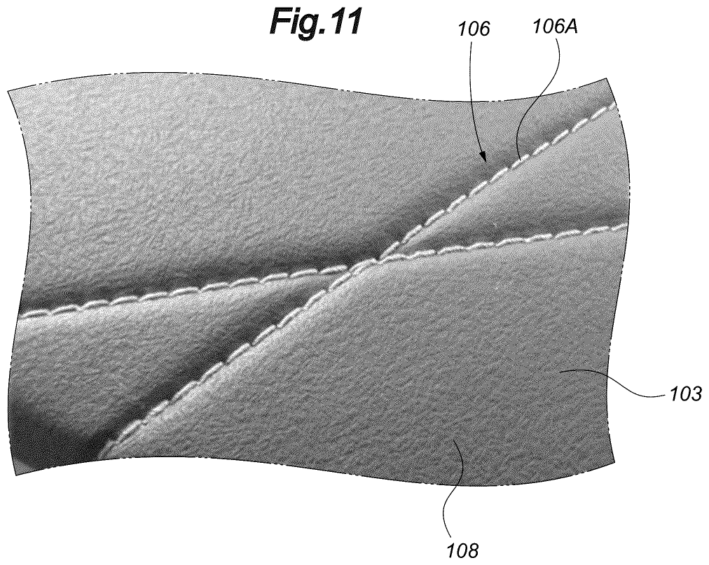

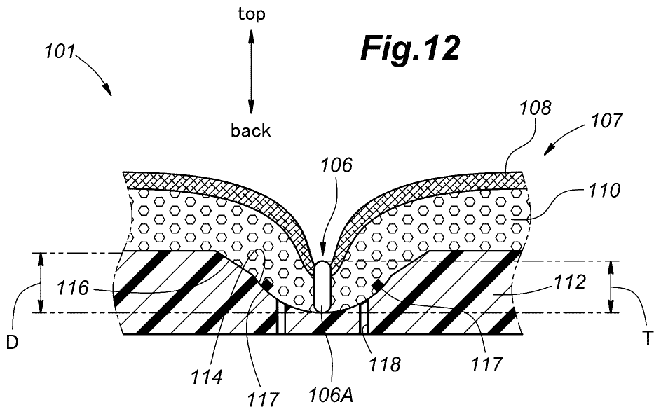

The skin material 107 is provided with the stitch 106 as a decorative member. The stitch 106 is formed by arranging the threads 106A, in which a plurality of fibers are woven, into the skin material 107 (the skin layer 108 and the foaming layer 110, described below). In the present embodiment, the stitch 106 is formed by the threads 106A extending in the prescribed direction of the surface direction of the skin material 107 while leaving spaces between each other (see FIG. 12). As shown in FIG. 11, the stitch 106 is arranged in a portion recessed from the surface of the skin material 107 towards the outboard side.

As shown in FIG. 12, the door trim 101 has the base material 112 joined to the skin material 107. The base material 112 is made of a hard resin having rigidity, and is formed so as to form the skeleton of the door trim 101. In other words, the base material 112 forms the skeleton of the main surface 103, the skeleton of the armrest 130, and the skeleton of the pull pocket body 132. The skin material 107 is provided so as to cover the inboard side of the base material 112.

The skin material 107 has the skin layer 108 and the foaming layer 110 provided on the surface of the skin layer 108 facing the base material 112. The skin layer 108 is disposed on the most inboard side of the door trim 101, i.e., in a position visible to the occupant. In order to ensure the design of the skin material 107, the skin layer 108 is formed in a sheet shape made of flexible resin, natural leather, synthetic leather, and the like.

The skin layer 108 may be composed of a thermoplastic elastomer (for example, an olefin-based thermoplastic elastomer (TPO), a polyvinyl chloride-based thermoplastic elastomer (TPVC), and the like) or polyvinyl chloride resin (PVC). Thermoplastic elastomers (TPO, TPVC, and the like) have rubber-like elasticity compared to polyvinyl chloride resin (PVC). This results in a pleasant feel when the occupant touches the skin material 107.

The foaming layer 110 is formed into a plate shape by foaming synthetic resin using a known method. The synthetic resin may be, for example, polyurethane resin (PUR), polystyrene resin (PS), polyolefin resin (polyethylene resin, polypropylene resin), and the like The foaming layer 110 gives the skin material 107 sound absorbing properties, which prevents sound from inside the vehicle cabin from leaking out of the vehicle. Further, the foaming layer 110 gives the skin material 107 cushioning properties, which also serves to protect the occupant in the event of a collision (shock mitigation).

In forming the door trim 101, first, the skin layer 108 and the foaming layer 110 are joined to form the skin material 107. The skin layer 108 and the foaming layer 110 may be joined by a known method such as a thermal fusion method. For example, they may be fused by pressing using a first die device having a first upper die and a first lower die that are movable in the up-and-down direction and can be opened and closed relative to each other. The skin layer 108 and the foaming layer 110 are arranged between the first upper die and the first lower die in a mutually overlapping state. Thereafter, the first upper die and the first lower die are closed to press the skin layer 108 and the foaming layer 110 in the up-and-down direction. At this time, the skin layer 108 and the foaming layer 110 are heated. Accordingly, the surface of the foaming layer 110 that contacts the skin layer 108 melts and then hardens, so that the skin layer 108 and the foaming layer 110 are fused together.

After the skin layer 108 and the foaming layer 110 are joined to form the skin material 107, the stitch 106 is formed by a sewing machine and the like. More specifically, the stitch 106 is provided such that the thread 106A alternately penetrates from the top surface visible to the occupant of the skin material 107 to the back surface and from the back surface to the top surface to sew together the skin layer 108 and the foaming layer 110, and extends in the prescribed direction of the surface direction of the skin material 107, i.e., the front-and-rear direction and the lateral direction. Accordingly, the stitch 106 has the thickness T that extends from the point of the thread 106A, the skin layer 108, and the foaming layer 110 that is arranged on the most front side of the skin material 107 to the point of the most back side of the skin material 107.

The stitch 106 is a decorative member, and the thread 106A does not have to be formed to sew the skin layer 108 and the foaming layer 110 together. For example, the thread 106A of the stitch 106 may be adhered to the top surface of the skin material 107 with an appropriate adhesive and the like. In other words, the stitch 106 is provided so as to protrude from the top surface of the skin material 107 on the inboard side.

The tape material 117 is provided in the portion of the skin material 107 where the stitch 106 is provided. The tape material 117 may be, for example, a polyvinyl chloride sheet-like vinyl tape with an adhesive applied to one side. The tape material 117 is adhered to the side edge of the foaming layer 110 that matches the end of the stitch 106 in a side view. There are no particular limitations on the position at which the tape material 117 is arranged, but it is preferable that it is arranged on the outside of each side of the thread 106A and on the inside of the groove 114 described below. There are no particular limitations on the width of each tape material 117, but it is preferable that it is set so as to fit within the width of the groove 114 described below. The tape material 117 may be provided along the direction in which the stitch 106 extends.

The top surface of the base material 112 to which the skin material 107 is joined is provided with the groove 114 that receives the portion of the skin material 107 on which the stitch 106 is provided. The groove 114 may be provided when the base material 112 is molded, or may be provided by an appropriate tool after the base material 112 is molded. The groove 114 is semicircular in cross section recessed from the top surface of the base material 112 toward the inside of the base material 112, and has the depth D from the top surface of the base material 112 to the bottom. The groove 114 is provided along the extension direction of the stitch 106. The depth D of the groove 114 is greater than the thickness T of the stitch 106.

The edge of the groove 114 is chamfered. That is, the edge of the groove 114 is provided with the chamfer 116 that slopes from the top surface of the base material 112 toward the bottom of the groove 114. When the stitch 106 is received in the groove 114, the front side of the stitch 106 is aligned with the component of the chamfer 116 in the depth direction of the groove 114.

A plurality of through holes 118 are formed in the base material 112, penetrating from the top surface of the base material 112 on which the groove 114 is provided to the back surface of the base material 112. Each of the plurality of through holes 118 is provided on each side of the center in the bottom of the groove 114 in a cross-sectional view. Furthermore, each of the plurality of through holes 118 may be arranged at intervals along the extension direction of the groove 114.

In still another embodiment, the base material 112 may have slits that penetrate from the top surface of the base material 112 on which the grooves 114 are provided to the back surface of the base material 112 and extend along the direction in which the grooves 114 extend. The slits may be provided on each side of the center in the bottom of the groove 114 in a cross-sectional view.

The door trim 101 is formed by bonding the skin layer 108 and the foaming layer 110 to form the skin material 107, and then bonding the skin material 107 and the base material 112.

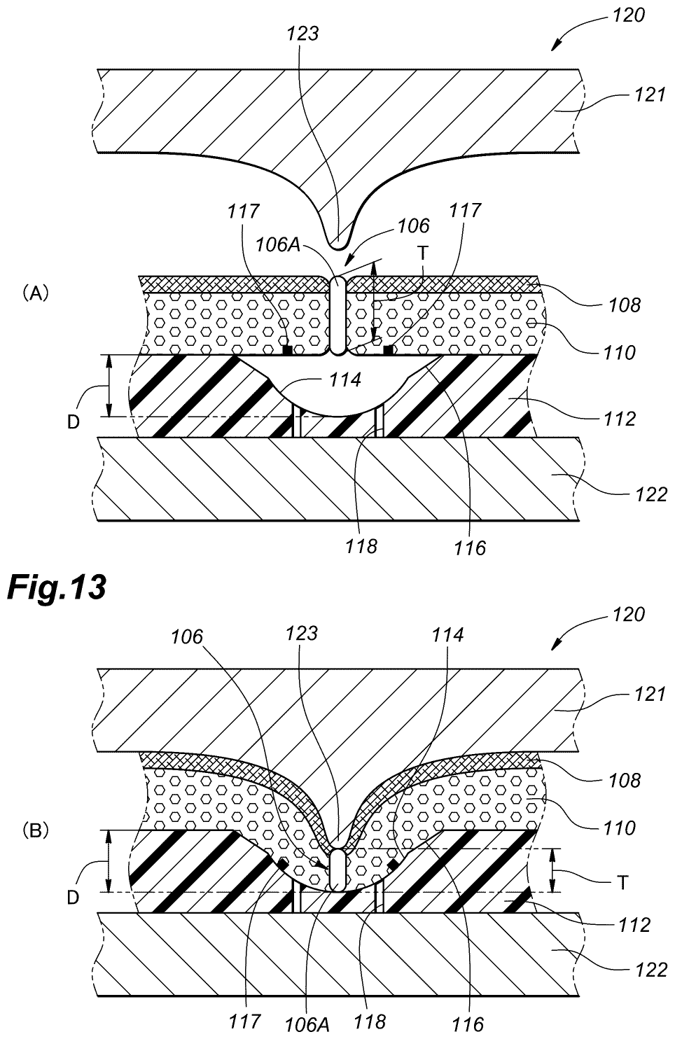

As shown in FIG. 13, the manufacturing device 120 for joining the skin material 107 and the base material 112 has the first die 121 and the second die 122 that are movable relative to each other in the pressing direction for pressing the skin material 107 and the base material 112. In the present embodiment, the pressing direction corresponds to the up-and-down direction of the paper, that is, the front-back direction that defines the front and back directions as viewed in the occupant. The first die 121 is disposed on the upper side of the paper, and the second die 122 is disposed on the lower side of the paper. The first die 121 moves in the front-back direction relative to the second die 122 by a cylinder (not shown). The first die 121 and the second die 122 are provided with a pair of projections and recesses that define the product shape of the door trim 101. In the present embodiment, the projections and recesses that define the product shape of the door trim 101 have been omitted to simplify the drawing.

The first die 121 is provided with the protrusion 123 protruding toward the second die 122. The protrusion 123 has a tapered shape in cross section that narrows as it protrudes toward the second die 122, and is provided along the extension direction of the groove 114 in the base material 112. The height of the protrusion 123 is equal to the depth D of the groove 114, and the width of the tip of the protrusion 123 is equal to the width of the thread 106A that forms the stitch 106. The side surface of the protrusion 123 is provided so as to curve toward the inside of the protrusion 123.

In yet another embodiment, the tip of the protrusion 123 may be formed in a semicircular shape when viewed in cross section to be received in the groove 114.

An air passage (not shown) is formed in the second die 122. The air passage may be recessed from the top surface of the second die 122 toward the inside of the second die 122 and provided along the prescribed surface direction of the top surface of the second die 122 so as to reach each edge of the second die 122.

The procedure for joining the skin material 107 and the base material 112 using the manufacturing device 120 configured in this manner will be described. The following operations are performed by an operator.

As shown in (A) of FIG. 13, the skin material 107 and the base material 112 are arranged on the manufacturing device 120 (the arranging step). More specifically, with the first die 121 and the second die 122 spaced apart from each other, the skin material 107 is arranged on the side of the first die 121, and the base material 112 is arranged on the side of the second die 122.

When the base material 112 is arranged, each of the plurality of through holes 118 provided in the base material 112 communicates with an air passage (not shown) provided in the second die 122. It is preferable that an adhesive be applied in advance to the top surface of the base material 112 that is to be joined to the skin material 107.

In another embodiment, instead of applying an adhesive to the base material 112, an adhesive film may be laminated to the surface of the foaming layer 110 that is to be joined to the base material 112. The adhesive film is a resin such as polyolefin resin or ethylene vinyl acetate resin, and is a so-called hot melt adhesive that melts when heated. The thickness and basis weight of the adhesive film may be appropriately selected so as to ensure the joint strength between the foaming layer 110 and the base material 112.

The skin material 107 is positioned such that the back surface of the foaming layer 110 abuts the top surface of the base material 112. The operator should position the skin material 107 on the base material 112 such that each tape material 117 on the side edges of the foaming layer 110 aligns with the grooves 114. At this time, the stitch 106 of the skin material 107 is positioned such that it aligns with the protrusion 123 of the first die 121. The skin material 107 is also in a heated and softened state.

After the skin material 107 and the base material 112 are arranged on the manufacturing device 120, the first die 121 and the second die 122 are moved close to each other as shown in (B) of FIG. 13, and the skin material 107 and the base material 112 are pressed together (the pressing step). More specifically, a cylinder (not shown) is operated to move the first die 121 toward the second die 122. Accordingly, the skin material 107 is pressed into the base material 112 while forming the product shape of the door trim 101. At this time, the tip of the protrusion 123 comes into contact with the thread 106A that forms the stitch 106, and then presses the stitch 106 toward the center in the bottom of the groove 114, and the side surface of the protrusion 123 presses the portion of the skin material 107 where the stitch 106 is provided into the groove 114. When the skin material 107 and the base material 112 are pressed together, the thickness T of the stitch 106 may be smaller than that before the pressing. The skin material 107 and the base material 112 are pressed together and the adhesive hardens, thereby bonding the skin material 107 and the base material 112. Thus, the door trim 101 is formed in which the stitch 106 is disposed in a recessed portion from the surface of the skin material 107 to the inside (the outboard side) of the skin material 107 (see FIG. 11).

The base material 112 is provided with the groove 114 for receiving the portion of the skin material 107 where the stitch 106 is provided. The manufacturing device 120 also has the protrusion 123 for pressing the portion of the skin material 107 where the stitch 106 is provided in the pressing step of pressing the skin material 107 and the base material 112 together. Accordingly, the stitch 106 is disposed in a portion recessed from the surface of the skin material 107 into the interior (the outboard side) of the skin material 107 (see FIG. 11). Accordingly, the top surface of the main surface 103 visible to the occupant is provided with a plurality of bumps, so that a three-dimensional pattern is formed on the main surface 103. That is, the design is further improved. Further, snagging by the occupant and the like is suppressed. Accordingly, damage to the stitch 106 is suppressed. That is, durability is further improved. Since the depth D of the groove 114 is set to be greater than the thickness T of the stitch 106, the stitch 106 is disposed in a recessed state from the top surface of the skin material 107 to the back surface.

The base material 112 is provided with a plurality of through holes 118 that penetrates from the top surface of the base material 112 on which the grooves 114 are provided to the back surface of the base material 112. Accordingly, when the portion of the skin material 107 on which the stitch 106 is provided is pressed against the grooves 114 provided in the base material 112, the air contained in the grooves 114 is pushed outwardly of the door trim 101 via the through holes 118. Accordingly, the air pool that is formed between the portion of the skin material 107 on which the stitch 106 is provided and the grooves 114 is suppressed.

When the base material 112 is arranged, each of the plurality of through holes 118 provided in the base material 112 communicates with an air passage (not shown) of the second die 122. Accordingly, in the pressing step in which the skin material 107 and the base material 112 are pressed together, the air contained in the grooves 114 passes through the air passage and is pushed outwardly of the door trim 101. Accordingly, the air pool that forms between the grooves 114 and the portion of the skin material 107 where the stitch 106 is provided is more effectively suppressed.

The edge of the groove 114 is provided with the chamfer 116 that slopes from the top surface of the base material 112 towards the bottom of the groove 114. This prevents damage to the skin material 107 caused by the edge of the groove 114 when the skin material 107 and the base material 112 are joined. Further, the front side of the stitch 106 is consistent with the component of the chamfer 116 in the depth direction of the groove 114. Accordingly, the stitch 106 is positioned in a state of being recessed from the top surface of the skin material 107 to the back surface.

The skin material 107 is provided with the tape material 117, which is arranged on the outside of each of the left and right sides of the stitch 106. In the arranging step of arranging the skin material 107 and the base material 112 on the manufacturing device 120, the tape material 117 is arranged so as to align with the groove 114. In other words, an operator can easily position the stitch 106 on the groove 114 using the tape material 117 as a guide.

### Ninth Embodiment

The manufacturing device 120 according to the ninth embodiment is different from the manufacturing device 120 according to the eighth embodiment in the configuration of the first die 121, and the other configurations are the same. In the following description, the same components as those of the vehicle interior material according to the first embodiment are given the same reference numerals, and the description thereof will be omitted.

The protrusion 123 provided in the first die 121 is provided so as to be movable in the front-to-back direction. More specifically, the protrusion 123 has a plate shape with a uniform width in a cross-sectional view, and is received in the receiving hole 123A provided in the first die 121. The receiving hole 123A penetrates from the top surface of the first die 121 that presses the skin material 107 to the back surface of the first die 121.

The width of the protrusion 123 is equal to the width of the thread 106A that constitutes the stitch 106. The protrusion 123 and the receiving hole 123A are provided along the direction in which the stitch 106 extends. The protrusion 123 is connected to a cylinder (not shown) and is provided so as to be movable in the front-to-back direction. In other words, the first die 121 is displaceable between a state where the tip of the protrusion 123 is received in the receiving hole 123A and a state where the tip of the protrusion 123 protrudes from the receiving hole 123A towards the second die 122.

In another embodiment, the protrusion 123 may be tapered such that the width narrows toward the tip. In this case, the receiving hole 123A that receives the protrusion 123 may be provided with a width equal to the base end side of the protrusion 123.

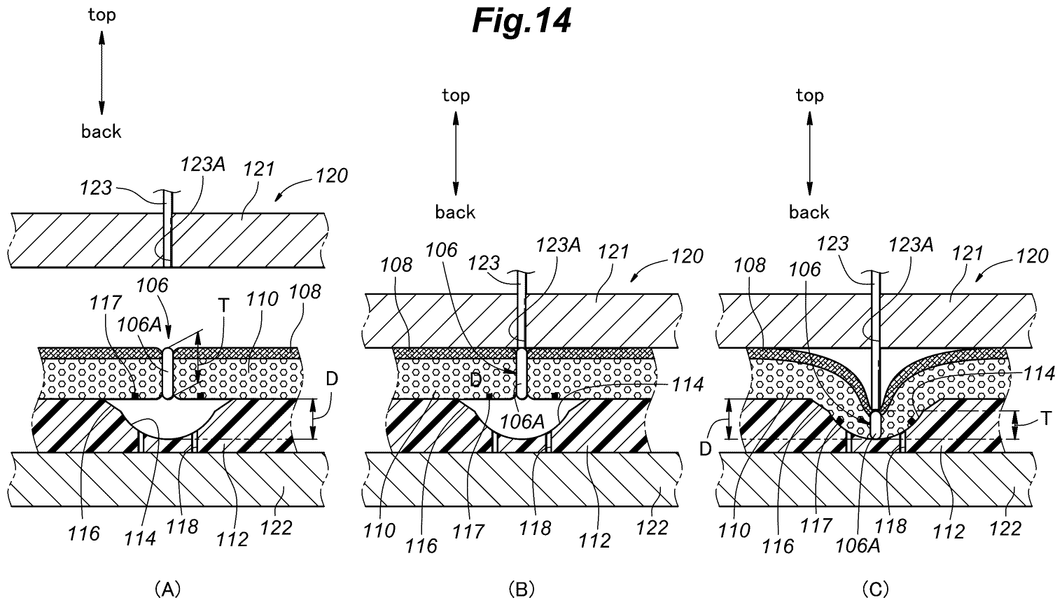

As shown in (A) of FIG. 14, the skin material 107 and the base material 112 are arranged on the manufacturing device 120 (the arranging step). More specifically, with the first die 121 and the second die 122 spaced apart from each other, the skin material 107 is arranged on the side of the first die 121, and the base material 112 is arranged on the side of the second die 122.

As shown in (B) of FIG. 14, in the pressing step in which the skin material 107 and the base material 112 are pressed together, the first pressing step is performed to press the portions of the skin material 107 other than the portion where the stitch 106 is provided onto the base material 112. At this time, the first die 121 is in a state where the tip of the protrusion 123 is received in the receiving hole 123A. Accordingly, the protrusion 123 abuts against the thread 106A that constitutes the stitch 106, but does not press the stitch 106.

As shown in (C) of FIG. 14, after the first pressing step, the protrusion 123 is moved and the second pressing step is performed to press the portion of the skin material 107 where the stitch 106 is provided against the groove 114. That is, the first die 121 is in a state where the tip of the protrusion 123 protrudes from the receiving hole 123A towards the second die 122 side by a cylinder (not shown). Accordingly, the protrusion 123 presses the thread 106A that forms the stitch 106 towards the groove 114, and in cooperation with this, the portion of the skin material 107 where the stitch 106 is provided also moves towards the groove 114.

As the adhesive hardens, the skin material 107 and the base material 112 are joined together. Thus, the door trim 101 is formed, with the stitch 106 positioned in a recessed portion inside (the outboard side) of the skin material 107 from the surface of the skin material 107 (see FIG. 11).

Since the pressing step, in which the skin material 107 and the base material 112 are pressed against each other, is performed in stages, that is, the first pressing step and the second pressing step, the air pool formed between the skin material 107 and the base material 112 is suppressed. More specifically, in the first pressing step, in which the portions of the skin material 107 other than the portion where the stitch 106 is provided are pressed against the base material 112, the air between the skin material 107 and the base material 112 is pushed outward from the door trim 101 through the through hole 118 via the groove 114 provided in the base material 112. In the first pressing step, the groove 114 is not closed by the corresponding skin material 107, and therefore functions as a larger air passage compared to the first embodiment. By performing the second pressing step after the first pressing step, the portion of the skin material 107 where the stitch 106 is provided is pressed so as to close the groove 114, and the air between the skin material 107 and the groove 114 is pushed outward from the door trim 101 via the through hole 118. Accordingly, the air pool formed between the skin material 107 and the base material 112 is suppressed.

The air pool formed between the skin material 107 and the base material 112 induces the skin material 107 to float relative to the base material 112. As the skin material 107 floats relative to the base material 112, there is a risk that the stitch 106 will be offset (misaligned) from the groove 114. The pressing step, in which the skin material 107 and the base material 112 are pressed against each other, is performed stepwise in the first pressing step and the second pressing step, thereby suppressing the air pool formed between the skin material 107 and the base material 112, and ultimately suppressing the misalignment of the stitch 106 from the groove 114. When an air pool is formed between the skin material 107 and the base material 112 in the first pressing step, the air pool is eliminated, and the second pressing step is performed in a state where the misalignment of the stitch 106 from the groove 114 is also eliminated.

This concludes the description of the specific embodiment, but the present invention is not limited to the above embodiment and can be modified in a wide range of ways. For example, in the present embodiment, each of the plurality of through holes 118 is provided in the groove 114 of the base material 112, but they may also be provided in portions of the base material 112 other than the groove 114. This more effectively suppresses the air pool that occurs between the skin material 107 and the base material 112 when the skin material 107 and the base material 112 are joined.

### Tenth Embodiment

In the following, an embodiment in which an interior material 210 is applied to an armrest 205 provided on a vehicle door 201 of an automobile will be described with reference to the drawings. In the following descriptions, “up-and-down direction”, “front-and-rear direction”, and “lateral direction” are defined based on the traveling direction of a vehicle.

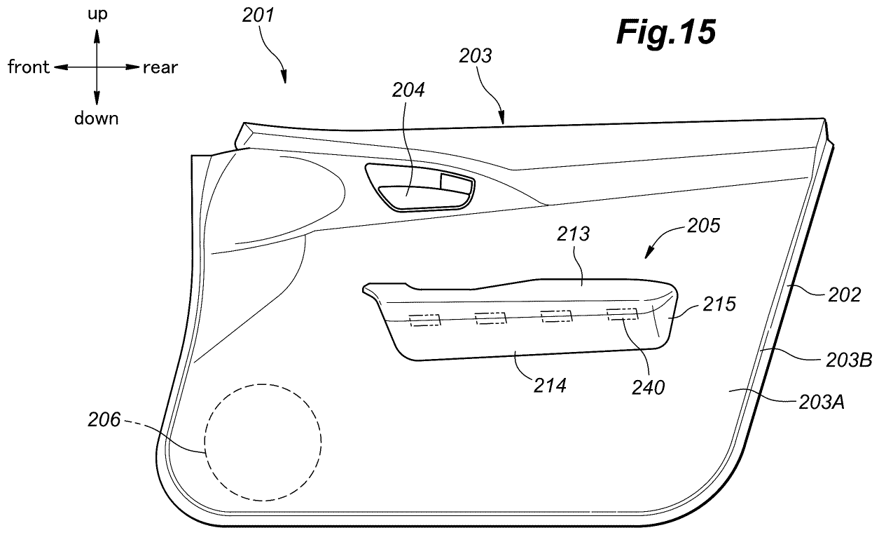

FIG. 15 is a front view of the vehicle door 201 arranged on a right side of the vehicle. The vehicle door 201 includes a door panel 202 as a skeleton member, and a door trim 203 provided to cover an inboard side surface of the door panel 202. The door panel 202 includes an inner panel and an outer panel that are formed of steel plates. The inner panel is joined to the outer panel at a front edge, a lower edge, and a rear edge excluding an upper edge, thereby forming a space in a central portion thereof.

The door trim 203 is formed of a resin material. The door trim 203 includes a trim body 203A having a surface facing the lateral direction and provided on an inboard side of the door panel 202, and a trim edge wall 203B protruding from a circumferential edge of the trim body 203A toward a side of the door panel 202 and abutting against an edge of the inboard side surface of the door panel 202. The trim edge wall 203B extends along the circumferential edge of the trim body 203A.

A door handle 204 for opening and closing the door is provided on an upper portion of the trim body 203A. A speaker 206 may be provided at a front lower portion of the trim body 203A. Further, a pocket portion bulging toward the inboard side may be provided in a lower portion of the trim body 203A arranged behind the speaker 206.

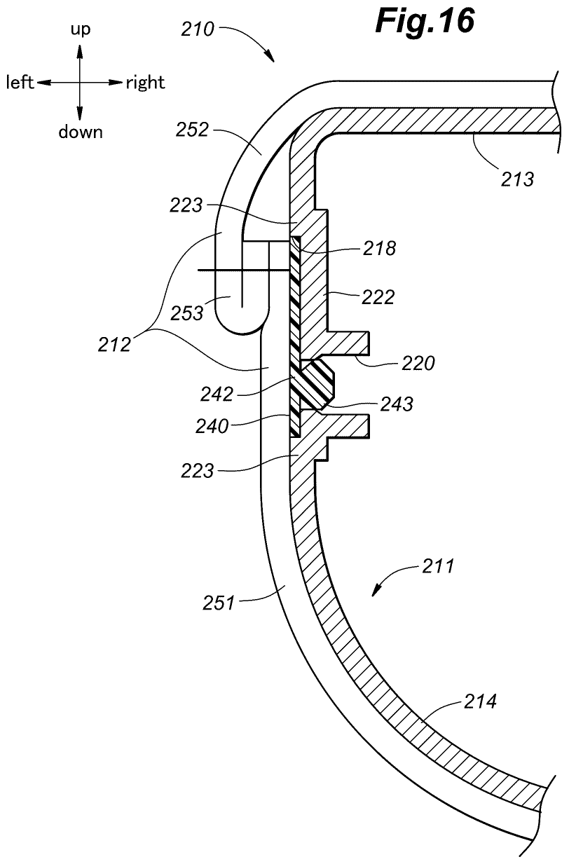

As shown in FIGS. 15 and 16, the armrest 205 is attached to a middle portion in the up-and-down direction of an inboard side surface of the trim body 203A. The armrest 205 is provided to extend in the front-and-rear direction. The armrest 205 includes a base material 211 that forms an outer shell thereof, and a skin material 212 that covers the base material 211.

The base material 211 is formed of a resin material. The base material 211 is coupled to the trim body 203A by screws and the like. The base material 211 includes an upper portion 213 connected to the trim body 203A, an inboard side portion 214, and a rear portion 215.

The upper portion 213 is a plate member protruding toward the inboard side relative to the trim body 203A and having a surface facing upward. The upper portion 213 can support the forearm of an occupant. The inboard side portion 214 is connected to the upper portion 213. The inboard side portion 214 is a plate member bent relative to the upper portion 213 and having a surface facing the inboard side and downward. Front ends of the upper portion 213 and the inboard side portion 214 are smoothly connected to the trim body 203A. Rear ends of the upper portion 213 and the inboard side portion 214 are connected by the rear portion 215 (curved plate portion). The rear portion 215 is a plate member having a bulging surface bulging toward the inboard side. A shallow groove 218 and a deep groove 220 are formed on the inboard side portion 214.

The shallow groove 218 (second groove) is a groove extending in the front-and-rear direction. The shallow groove 218 is recessed so as to open toward the inboard side. The shallow groove 218 includes a second bottom 222 that forms a bottom surface thereof, and upper and lower second walls 223 connected to the second bottom 222. The second bottom 222 has a flat surface facing the inboard side. The upper and lower second walls 223 extend vertically from upper and lower ends of the second bottom 222 toward the inboard side. The upper and lower second walls 223 each have a surface facing upward and a surface facing downward. The upper and lower second walls 223 are each connected to the inboard side portion 214. The deep groove 220 (first groove) extending in the front-and-rear direction is recessed in the second bottom 222.

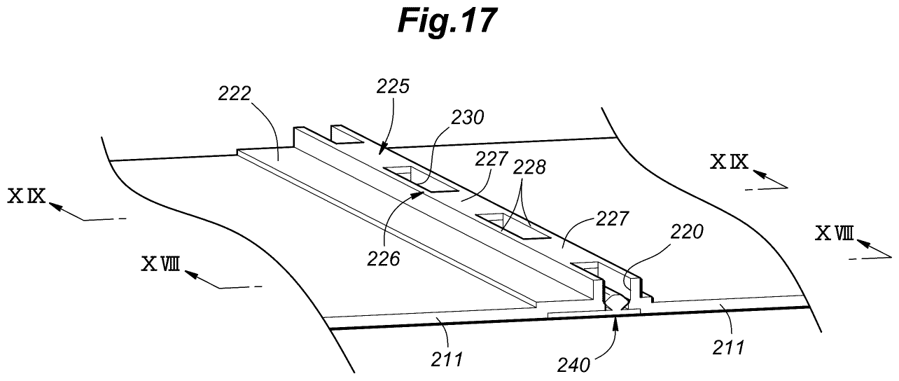

FIG. 17 is a schematic perspective view showing an outboard side surface of the inboard side portion 214. The deep groove 220 includes closed areas 225 and opening areas 226. The closed areas 225 and the opening areas 226 are arranged alternately along the extending direction of the deep groove 220.

As shown in FIGS. 17 to 19, the closed areas 225 indicate areas in which a portion that constitutes the bottom of the deep groove 220 is completely covered. In the closed areas 225, the deep groove 220 includes a first bottom 227 that constitutes a bottom surface thereof. The first bottom 227 has a flat surface facing the inboard side. One end of each of two first walls 228 is connected to the first bottom 227. Each of the first walls 228 extends vertically from an end of the first bottom 227. The other ends of the first walls 228 are connected to the second bottom 222. The first walls 228 have surfaces facing each other.

The opening areas 226 indicate areas in which the portion that constitutes the bottom of the deep groove 220 is not covered (i.e., open). In the opening areas 226, the deep groove 220 does not include the first bottom 227. First holes 230 are formed at the bottom of the deep groove 220. The first holes 230 are holes penetrating in the vehicle width direction. The first hole 230 is defined by the two first walls 228 extending vertically from the second bottom 222, and the first bottom 227 of two adjacent closed areas 225. The first walls 228 in the opening areas 226 is connected to the first walls 228 in the adjacent closed areas 225. Retaining portions 231 are formed in the two first walls 228 of the opening areas 226, respectively.

The retaining portions 231 are protrusions that protrude from the first walls 228 on surfaces that define the deep groove 220. The retaining portions 231 are provided at positions facing each other in the up-and-down direction of the vehicle. That is, the dimension in the up-and-down direction of the deep groove 220 at portions where the retaining portions 231 are provided is smaller than the dimension in the up-and-down direction of the deep groove 220 at portions where the retaining portions 231 are not provided.

Steps 233 are formed on the outboard side surface of the inboard side portion 214. The steps 233 have a surface that extends perpendicularly from the outboard side surface of the inboard side portion 214 toward an outboard side. The steps 233 connect the outboard side surface of the inboard side portion 214 and an outboard side surface of the second bottom 222.

As shown in FIG. 16, the deep groove 220 is offset downward relative to the shallow groove 218. That is, as the deep groove 220 is formed, the dimension in the up-and-down direction of the second bottom 222 arranged upward of the deep groove 220 is greater than the dimension in the up-and-down direction of the second bottom 222 arranged downward of the deep groove 220. The depth of the deep groove 220 is shallower than the depth of the shallow groove 218. The length in the front-and-rear direction of the deep groove 220 may be the same as the length in the front-and-rear direction of the shallow groove 218. A plurality of shallow grooves 218 and a plurality of deep grooves 220 may be provided along the front-and-rear direction of the vehicle. An engagement member 240 fits into the shallow groove 218 and the deep groove 220.

The engagement member 240 is a member for attaching the skin material 212 to the base material 211. The engagement member 240 is formed of synthetic resin such as polypropylene or polycarbonate. The engagement member 240 fits into the shallow groove 218 and the deep groove 220 from the outboard side. The engagement member 240 includes a plate 242, and a locked portion 243 protruding from the plate 242.

The plate 242 fits into the shallow groove 218. In a fitting state thereof, an inboard side surface of the plate 242 is flush with an inboard side surface of the inboard side portion 214. The locked portion 243 is connected to an outboard side surface of the plate 242.

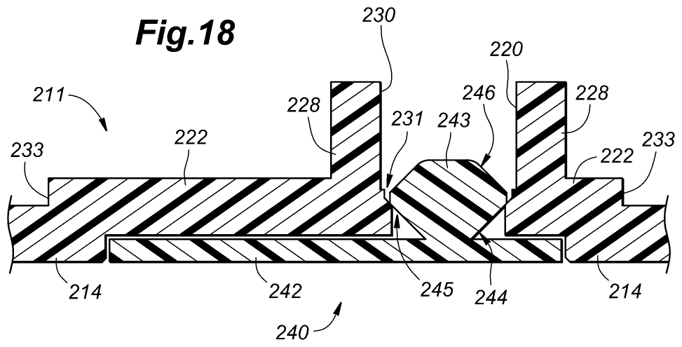

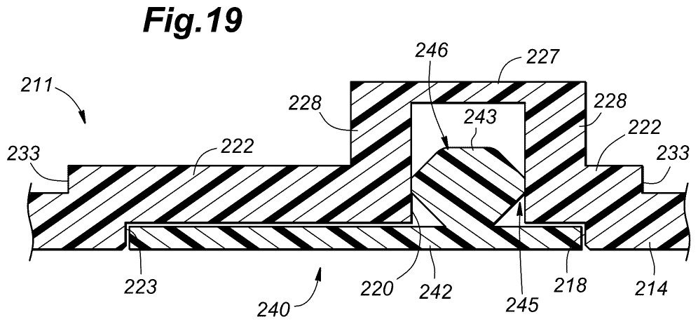

As shown in FIGS. 18 and 19, the locked portion 243 fits into the deep groove 220. In a fitting state thereof, the locked portion 243 is received by the first bottom 227 and the first walls 228 in the closed areas 225. The locked portion 243 is received by the first walls 228 in the opening areas 226. That is, the first bottom 227 and the first walls 228 constitute receiving portions 227, 228 that receive the locked portion 243.

The locked portion 243 is a member formed into a substantially hexagonal shape when viewed in the front-and-rear direction. The locked portion 243 is composed of a base portion 244, a central portion 245, and a tip portion 246. The base portion 244 is connected to the plate 242. The central portion 245 is connected to the base portion 244. The tip portion 246 is connected to the central portion 245. In the closed areas 225, the central portion 245 abuts against the first walls 228. In the opening areas 226, the central portion 245 is locked by the retaining portions 231. The central portion 245 may have engagement claws locked by the retaining portions 231. The dimension in the up-and-down direction of the central portion 245 is greater than the dimension in the up-and-down direction of the base portion 244. The dimension in the up-and-down direction of the central portion 245 is greater than the dimension in the up-and-down direction of the tip portion 246. The tip portion 246 has a surface facing the outboard side. That is, the tip portion 246 faces a surface of the first bottom 227 facing the inboard side in the closed areas 225. In the closed areas 225, the length of the locked portion 243 from the base portion 244 to the tip portion 246 (i.e., the length of the locked portion 243 in the vehicle width direction) is smaller than the thickness of the first bottom 227 in the vehicle width direction.

As shown in FIG. 16, the locked portion 243 is offset downward relative to the plate 242. That is, the plate 242 has different lengths in the up-and-down direction in an upper area arranged upward of the locked portion 243 and in a lower area arranged downward of the locked portion 243. The dimension in the up-and-down direction of the upper area of the plate 242 is longer than the dimension in the up-and-down direction of the lower area of the plate 242. In the upper area, the skin material 212 is sewn to the inboard side surface of the plate 242.

The skin material 212 is a decorative member for decorating the inside of a vehicle cabin. The skin material 212 is formed of a sheet material such as genuine leather, synthetic leather, or a resin sheet. The skin material 212 includes a first skin portion 251, and a second skin portion 252 connected to the first skin portion 251. The first skin portion 251 and the second skin portion 252 may be provided with the same decoration, or may be provided with the decoration different in colors, patterns, materials, and the like. That is, the first skin portion 251 and the second skin portion 252 may be formed of the same sheet, or may be formed of different sheets.

The first skin portion 251 covers a portion of the inboard side portion 214 of the base material 211. The second skin portion 252 covers the upper portion 213 and a portion of the inboard side portion 214 of the base material 211. The first skin portion 251 and the second skin portion 252 form an overlapping portion 253 where the tips of each of the first skin portion 251 and the second skin portion 252 overlap. In the overlapping portion 253, the first skin portion 251 is arranged closer to the inboard side than the second skin portion 252. The tip of the second skin portion 252 is folded back to the outboard side. The skin material 212 is sewn to the engagement member 240 at the overlapping portion 253. Accordingly, an upper end of the first skin portion 251 and a lower end of the second skin portion 252 are connected.

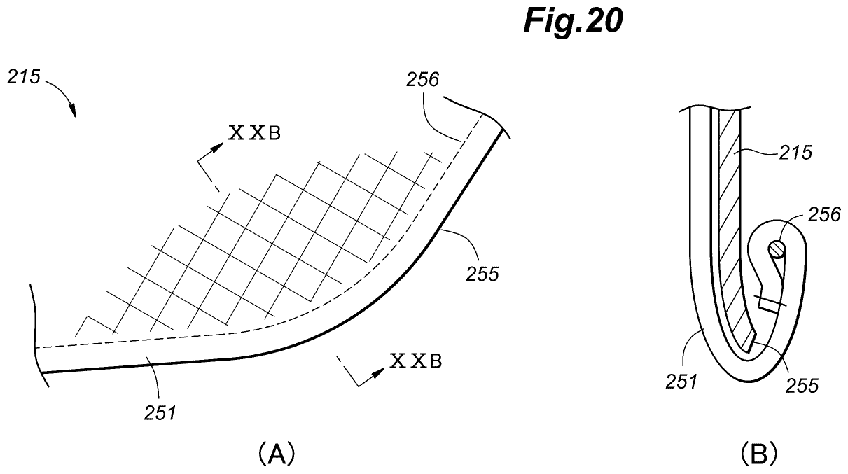

FIG. 20 shows a rear end of the first skin portion 251 attached to the rear portion 215. The first skin portion 251 covers the rear portion 215 at a lower portion of a rear end of the armrest 205 (shown in FIG. 15). The rear portion 215 has an arc-like edge 255 having an arc-like shape when viewed in the front-and-rear direction. The arc-like edge 255 defines an outer edge of the rear portion 215. The rear end of the first skin portion 251 extends from the inboard side to the outboard side to cover the arc-like edge 255. A resilient wire 256 is provided at an outboard side surface of the rear portion 215 at a position of the first skin portion 251 corresponding to the arc-like edge 255.

The resilient wire 256 is a metal member having elasticity. The resilient wire 256 extends along the arc-like edge 255. The resilient wire 256 is supported inside the first skin portion 251 as the first skin portion 251 is folded back toward the outboard side. An end of the first skin portion 251 is sewn so as to wind around the resilient wire 256. The resilient wire 256 resiliently abuts against the outboard side surface of the rear portion 215 via the first skin portion 251. As the resilient wire 256 abuts against the outboard side surface of the rear portion 215, the rear end of the first skin portion 251 is locked on the rear portion 215.

In the foregoing, the rear end of the first skin portion 251 is described with reference to FIG. 20. The configuration to attach the skin material 212 to the base material 211 using the resilient wire 256 is similarly applied to a front end and an upper portion of a rear end of the armrest 205. That is, a rear end of the second skin portion 252 and front ends of the first skin portion 251 and the second skin portion 252 are attached to the base material 211 using the resilient wire 256 in a similar manner.

Further, a lower end of the first skin portion 251 and both ends of the second skin portion 252 may be attached to the base material 211 by a method such as heat compression or ultrasonic welding. A plurality of locking members (not shown) are sewn to outer edges of the upper portion 213 and the inboard side portion 214 on inboard side surfaces thereof. The locking members may be a hot melt film or a trim cord film. The locking members may have the same material composition as the base material 211.

Next, an assembling method of the interior material 210 according to the present embodiment will be described. First, the first skin portion 251 and the second skin portion 252 to be attached to the base material 211 and the engagement member 240 are prepared. Next, an end (i.e., an upper end) of the first skin portion 251 overlaps with the plate 242 of the engagement member 240. At this time, the first skin portion 251 is arranged such that the end of the first skin portion 251 overlaps with the upper area of the plate 242.

More specifically, the engagement member 240 is arranged such that one end included in two ends of the plate 242 farther away from a connection portion with the locked portion 243 faces upward. The first skin portion 251 is arranged from below such that the upper end thereof overlaps with the upper area of the plate 242. Accordingly, the first skin portion 251 is arranged relative to the engagement member 240.

Then, an end (i.e., a lower end) of the second skin portion 252 is folded back. Next, the second skin portion 252 is arranged on the first skin portion 251 such that the folded portion is sandwiched between the remaining portion of the second skin portion 252 and the first skin portion 251. Accordingly, the overlapping portion 253 in which the upper end of the first skin portion 251 and the lower end of the second skin portion 252 overlap with each other is formed. Next, the overlapping portion 253 and the plate 242 are sewn together. Accordingly, the skin material 212 and the engagement member 240 are coupled together.

Next, the engagement member 240 is attached to the base material 211. First, the plate 242 fits into the shallow groove 218 provided in the inboard side portion 214 of the base material 211. At this time, an upper end side (that is, a side where the overlapping portion 253 is arranged) of the plate 242 may be pressed against the second wall 223 arranged upward of the shallow groove 218, and a lower end side of the plate 242 may be pressed into the shallow groove 218.

Next, as the plate 242 is pressed from the inboard side toward the outboard side, the locked portion 243 is pressed into the deep groove 220. As the deep groove 220 is provided with the retaining portions 231 in the opening areas 226, the operator may press the engagement member 240 firmly against the base material 211 at the opening areas 226. Accordingly, the locked portion 243 is locked by the retaining portions 231, and the engagement member 240 engages with the base material 211. As the above process is repeated and a plurality of engagement members 240 is attached to the corresponding deep grooves 220 and shallow grooves 218, the first skin portion 251 and the second skin portion 252 are attached to the base material 211 at the inboard side portion 214.

Next, a rear end side of the skin material 212 is attached to the base material 211. First, the resilient wire 256 is attached to the rear end of the skin material 212 composed of the rear end of the first skin portion 251 and the rear end of the second skin portion 252. More specifically, the resilient wire 256 is provided on the outboard side of the rear end of the skin material 212. At this time, the resilient wire 256 may be arranged to extend along the rear end of the skin material 212. Next, the rear end of the skin material 212 is folded back to the outboard side, and the resilient wire 256 is wound from the outboard side to the inboard side. The folded portion is sewn to the corresponding inboard side portion of the skin material 212. Accordingly, the resilient wire 256 is wrapped and supported inside the folded portion of the skin material 212.

Thereafter, the rear end of the skin material 212 supporting the resilient wire 256 is arranged along the rear portion 215 of the base material 211. More specifically, the rear end of the skin material 212 covers the arc-like edge 255 that defines the outer edge of the rear portion 215. The operator folds back the rear end of the skin material 212, which covers the arc-like edge 255 from the inboard side, from the outboard side toward the inboard side.

The resilient wire 256 supported by the rear end of the skin material 212 resiliently abuts against the outboard side surface of the rear portion 215. Accordingly, the rear end of the skin material 212 is locked on the outboard side surface of the rear portion 215. Accordingly, the skin material 212 is attached to the base material 211 at the rear portion 215. Thereafter, a front end side of the skin material 212 is attached to the base material 211. The assembling method for the front end side of the skin material 212 is similar to the assembling method for the rear end side of the skin material 212, and therefore the descriptions thereof will be omitted.

Next, a lower end side of the skin material 212 (i.e., a lower end side of the first skin portion 251) is attached to the base material 211. First, the lower end of the first skin portion 251 is folded back to cover an outer edge of the inboard side portion 214 of the base material 211. Accordingly, the folded portion of the first skin portion 251 is arranged to overlap with an outboard side surface of the outer edge of the inboard side portion 214. At this time, the operator arranges the folded portion of the first skin portion 251 on the locking members (hot melt film) provided on the outboard side surface of the outer edge of the inboard side portion 214. Next, the folded portion of the first skin portion 251 is heated from above. Accordingly, the hot melt film melts, and the first skin portion 251 and the base material 211 are attached together. As the above process is repeated for the plurality of locking members, the first skin portion 251 is attached to the base material 211 at the inboard side portion 214. The assembling method for an upper end side of the skin material 212 (i.e., an upper end side of the second skin portion 252) is similar to the assembling method for the lower end side of the skin material 212, and therefore the descriptions thereof will be omitted.

Accordingly, the interior material 210 that constitutes the armrest 205 according to the present embodiment is assembled. The assembling order described above does not limit the embodiment, and may be changed as appropriate. For example, either the front end side or the rear end side of the skin material 212 may be attached first. Further, either the upper end side or the lower end side of the skin material 212 may be attached first. Further, the resilient wire 256 may be sewn to the skin material 212 in advance.

In the following, the effects of the vehicle interior material 210 according to the present embodiment will be described. The interior material 210 includes the base material 211, the skin material 212, and the engagement member 240. The base material 211 is provided on the inboard side of a panel of a vehicle body. The skin material 212 covers the base material 211 from the inboard side. The skin material 212 is attached to the base material 211 by the engagement member 240. The deep groove 220 (first groove) and the shallow groove 218 (second groove) formed around the deep groove 220 are formed on the inboard side surface of the base material 211. The depth of the shallow groove 218 is shallower than the depth of the deep groove 220. The engagement member 240 includes the plate 242, and the locked portion 243 protruding from the plate 242. The plate 242 is coupled to an outboard side surface of the skin material 212, and is received by the shallow groove 218. The locked portion 243 is inserted into the deep groove 220, and is locked by the deep groove 220. The inboard side surface of the plate 242 is flush with the inboard side surface of the base material 211. Accordingly, it is possible to attach the skin material 212 to the base material 211 by pushing the engagement member 240 into the deep groove 220 and the shallow groove 218. Accordingly, it is possible to facilitate the attachment of the skin material 212 to the base material 211. Further, since the inboard side surface of the plate 242 is flush with the inboard side surface of the base material 211, it is possible to attach the engagement member 240 flat to the base material 211. Accordingly, when viewed from the inboard side, an unintended step is not generated on a top surface of the interior material 210.

The skin material 212 includes the first skin portion 251 and the second skin portion 252. The first skin portion 251 and the second skin portion 252 overlap with each other, thereby forming the overlapping portion 253. The skin material 212 is sewn to the plate 242 at the overlapping portion 253. Since the plate 242 is a plate member that is thinner than the locked portion 243, it is possible to easily attach two portions of the skin material 212 to the engagement member 240 by sewing.

The second skin portion 252 is arranged closer to the inboard side than the first skin portion 251. Furthermore, the second skin portion 252 is folded back to the outboard side at the overlapping portion 253. The second skin portion 252 is arranged on the inboard side, so that the tip of the first skin portion 251 is covered with the second skin portion 252 when viewed from the inboard side. The second skin portion 252 is folded back to the outboard side, so that the tip of the second skin portion 252 is not visible from the inboard side. Further, the second skin portion 252 is folded back at the overlapping portion 253, so that the folded portion is sewn to the plate 242 together with the first skin portion 251. Accordingly, the folded tip of the second skin portion 252 is not exposed to the inboard side. Accordingly, the appearance inside the vehicle cabin can be improved.

The locked portion 243 is offset downward (i.e., toward the first skin portion 251) relative to the plate 242. Accordingly, the upper area of the plate 242 arranged upward of the locked portion 243 (i.e., arranged on a side of the second skin portion 252) can be made larger than the lower area of the plate 242 arranged downward of the locked portion 243 (i.e., arranged on a side of the first skin portion 251). Accordingly, it is possible to easily sew the skin material 212 to the plate 242. Further, by adopting such a configuration, the engagement member 240 is formed asymmetrically in the up-and-down direction. Accordingly, the attachment direction of the skin material 212 can be easily determined, particularly when the sheets made of the same or similar material are used for the first skin portion 251 and the second skin portion 252. Accordingly, the workability is improved.

The deep groove 220 includes the retaining portions 231 for locking the locked portion 243. Accordingly, when the engagement member 240 is pressed against the base material 211, the locked portion 243 is locked by the retaining portions 231. Accordingly, it is possible to securely lock the engagement member 240 by the base material 211. Accordingly, it is possible to securely attach the skin material 212 to the base material 211.

The deep groove 220 includes the upper and lower first walls 228 extending from the base material 211 to the outboard side, and the first bottom 227 connecting the upper and lower first walls 228. The first bottom 227 and the first walls 228 constitute the receiving portions 227, 228. The receiving portions 227, 228 cover the locked portion 243 inserted into the deep groove 220 from the outboard side. The deep groove 220 includes the opening areas 226 and the closed areas 225. In the opening areas 226, the receiving portions 227, 228 include the first holes 230 facing the locked portion 243. In the closed areas 225, the receiving portions 227, 228 do not include the first holes 230. Further, the thickness of the first bottom 227 is smaller than the thickness of the locked portion 243. Accordingly, when the locked portion 243 is inserted into the deep groove 220, the first bottom 227 is likely to bend. Accordingly, the engagement member 240 can be easily attached to the base material 211.

The retaining portions 231 are arranged at positions corresponding to the opening areas 226. In the opening areas 226, the receiving portions 227, 228 include the first holes 230. Accordingly, when the locked portion 243 is inserted into the deep groove 220, the receiving portions 227, 228 are likely to bend. Accordingly, it is possible to easily lock the locked portion 243 by the retaining portions 231. Further, the attachment of the engagement member 240 is facilitated as compared with a case where the retaining portions 231 are provided over both the opening areas 226 and the closed areas 225. Accordingly, the workability is improved.

The base material 211 includes the plate-like rear portion 215 having a bulging surface bulging toward the inboard side. The rear portion 215 includes the arc-like edge 255 that defines an outer edge of the bulging surface and is arc-shaped in a side view. The skin material 212 is provided to cover the bulging surface from the inboard side. The resilient wire 256 extending along the arc-like edge 255 at the outboard side surface of the rear portion 215 is provided at a position corresponding to the rear portion 215 of the skin material 212. The resilient wire 256 resiliently abuts against the outboard side surface of the curved plate portion so as to lock the skin material 212 on the arc-like edge 255. Accordingly, the outer edge of the skin material 212 is attached to the base material 211 by the resilient wire 256. Accordingly, the attachment work is facilitated.

The interior material 210 constitutes the armrest 205 of the vehicle door 201, and the plurality of engagement members 240 is arranged along the longitudinal direction of the armrest 205. Accordingly, it is possible to provide the armrest 205 including the interior material 210 that facilitates the attachment of the skin material 212 to the base material 211 and enables the engagement members 240 to be attached flat to the base material 211. Further, since the plurality of engagement members 240 is provided, the skin material 212 can be securely attached even when the area of the base material 211 to which the skin material 212 is attached is large.

The steps 233 are formed on the outboard side surface of the inboard side portion 214. Accordingly, the strength of the base material 211 is increased, so that the base material 211 is not damaged when the engagement member 240 is attached.

Further, at least a portion of the resilient wire 256 is aligned with the engagement member 240 in the up-and-down direction and the lateral direction when viewed in the front-and-rear direction. Accordingly, it is possible to arrange the resilient wire 256 compactly. Accordingly, it is possible to configure the interior material 210 compactly as a whole.

Furthermore, the locking members have the same material composition as the base material 211. Accordingly, it is possible to stably fix the skin material 212 to the base material 211 regardless of the type of the skin material 212.

In the above embodiment, the interior material 210 constitutes the armrest 205, but is not limited to this. For example, the interior material 210 may constitute the door trim 203, or may constitute a console box and the like provided in the vehicle cabin. Further, the interior material 210 may constitute a side cover provided on a side of a seat cushion of a vehicle seat. Further, the interior material 210 may constitute the vehicle seat itself.

### Glossary of Terms

1: door trim (vehicle interior material)
6: base material
7: skin material
8: skin layer
9: foaming layer
10: solid layer
12: first recess
14: second recess
16: first through hole
31: second through hole

1. A vehicle interior material, comprising:
a base material; and
a skin material joined to the base material,
wherein the skin material includes:
a skin layer;
a foaming layer provided on a surface of the skin layer on a side of the base material; and
a solid layer provided on a surface of the foaming layer on the side of the base material and having a higher density than the foaming layer, and
the skin material has a plurality of first recesses recessed from the solid layer toward the foaming layer.

2. The vehicle interior material according to claim 1, wherein each of a bottom of the plurality of first recesses reaches the foaming layer.

3. The vehicle interior material according to claim 1, wherein a surface of the base material joined to the solid layer has a plurality of second recesses recessed toward an inside of the base material.

4. The vehicle interior material according to claim 3, wherein when the base material and the skin material are joined together, a portion of the plurality of first recesses and a portion of the plurality of second recesses are arranged to face each other.

5. The vehicle interior material according to claim 4, wherein the foaming layer is breathable, and
the skin layer has a plurality of first through holes penetrating from a top surface of the skin layer to a back surface of the skin layer.

6. The vehicle interior material according to claim 5, wherein each of the plurality of first through holes is aligned with a portion of the plurality of first recesses in a side view.

7. The vehicle interior material according to claim 6, wherein when the skin material and the base material are joined together, each of the plurality of first through holes is aligned with a portion of the plurality of second recesses in a side view.

8. The vehicle interior material according to claim 1, wherein the base material has a plurality of second through holes penetrating from a top surface of the base material to a back surface of the base material.

9. The vehicle interior material according to claim 8, wherein when the skin material and the base material are joined together, each of the plurality of second through holes is aligned with a portion of the plurality of first recesses in a side view.

10. The vehicle interior material according to claim 9, wherein the skin layer has a plurality of first through holes penetrating from a top surface of the skin layer to a back surface of the skin layer, and
when the skin material and the base material are joined together, each of the plurality of second through holes is aligned with a portion of the plurality of first through holes in a side view.
